(19) United States
(12) Patent Application Publication
(10) Pub. No.: US 2025/0392680 A1
(43) Pub. Date: Dec. 25, 2025

(54) IMAGE PROCESSING APPARATUS, METHOD, AND STORAGE MEDIUM STORING PROGRAM

(71) Applicant: CANON KABUSHIKI KAISHA, Tokyo (JP)

(72) Inventors: FUMINO MATSUI, Kanagawa (JP); SHINICHI MIYAZAKI, Kanagawa (JP); MASAAKI OBAYASHI, Kanagawa (JP); AKITOSHI YAMADA, Kanagawa (JP); HISASHI ISHIKAWA, Chiba (JP)

(21) Appl. No.: 19/236,893

(22) Filed: Jun. 12, 2025

(30) Foreign Application Priority Data
Jun. 21, 2024 (JP) 2024-100743

(51) Int. Cl. H04N 1/60

(52) U.S. Cl. CPC H04N 1/6066; H04N 1/603; H04N 1/6025

(57) ABSTRACT

An image processing apparatus includes: a setting unit configured to, on a basis of the information indicating a characteristic of the color information of the first color gamut obtained by the second obtaining unit, set color information corresponding to a target for suppressing correction by the correction unit from among the color information of the first color gamut obtained by the first obtaining unit; and a control unit configured to control the correction unit to suppress correction of color information set by the setting unit.

### BACKGROUND

### Field of the Technology

The present disclosure relates to an image processing apparatus that can execute mapping, a method for the image processing apparatus, and a storage medium storing a program.

### Description of the Related Art

It is known that correction can be performed of a mapping destination in a color gamut according to input data when, after a digital document described in a predetermined color space is received, performing mapping for each color in this color space to a color gamut that can be reproduced by a printer. Japanese Patent Laid-Open No. 2024-008263 describes increasing the distance between colors, from among the input colors, that are susceptible to color degeneration so that color mapping to a print color gamut is performed to reduce the degree of color degeneration.

### SUMMARY

The present disclosure provides an image processing apparatus that enables correction of a mapping result to be controlled, a method, and a storage medium storing a program.

An aspect of the present disclosure provides an image processing apparatus comprising: a first obtaining unit configured to obtain color information of a first color gamut specified in image data; a color conversion unit configured to convert the color information of the first color gamut obtained by the first obtaining unit into color information of a second color gamut narrower than the first color gamut; a correction unit configured to correct the color conversion unit so that a conversion destination in the second color gamut for conversion by the color conversion unit of the color information of the first color gamut is changed; a second obtaining unit configured to obtain information indicating a characteristic of the color information of the first color gamut obtained by the first obtaining unit in an image represented by the image data; a setting unit configured to, on a basis of the information indicating a characteristic of the color information of the first color gamut obtained by the second obtaining unit, set color information corresponding to a target for suppressing correction by the correction unit from among the color information of the first color gamut obtained by the first obtaining unit; and a control unit configured to control the correction unit to suppress correction of color information set by the setting unit.

According to the present disclosure, correction of a mapping result can be controlled. As a result, the same color across different regions can be prevented from becoming different colors across the regions.

Further features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating the configuration of an image processing apparatus.

FIG. 2 is a diagram for describing a print head.

FIG. 3 is a flowchart illustrating the overall processing of the image processing apparatus.

FIG. 4 is a flowchart illustrating processing for generating a post-color-degeneration-correction table.

FIG. 5 is a diagram for describing detection of a number of combinations of colors showing color degeneration.

FIG. 6 is a flowchart illustrating processing of step S102.

FIG. 7 is a diagram illustrating document data.

FIG. 8 is a diagram illustrating color supplementary information.

FIG. 9 is a diagram for describing a paper end region.

FIG. 10 is a flowchart illustrating the overall processing of the image processing apparatus.

FIG. 11 is a flowchart illustrating processing of step S1002.

FIG. 12 is a flowchart illustrating the overall processing of the image processing apparatus.

FIG. 13 is a flowchart illustrating the overall processing of the image processing apparatus.

FIG. 14 is a flowchart illustrating processing of step S1302.

FIG. 15 is a diagram illustrating a user interface screen.

FIG. 16 is a diagram illustrating a user interface screen.

FIG. 17 is a diagram illustrating a user interface screen.

FIG. 18 is a diagram for describing color degeneration determination processing of step S202.

FIG. 19 is a diagram for describing color degeneration correction processing of step S205.

FIG. 20 is a diagram for describing color degeneration correction processing of step S205.

FIG. 21 is a diagram illustrating a correction table for expanding lightness in a lightness direction.

FIG. 22 is a diagram illustrating a correction table for expanding lightness in the lightness direction.

FIGS. 23A and 23B are diagrams illustrating correction tables for expanding lightness in the lightness direction.

FIGS. 24A and 24B are diagrams illustrating correction tables for expanding lightness in the lightness direction.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

In a case where correction is performed on a result of mapping according to an input color in a region such as a page, the same color across different regions may problematically become different colors across the regions.

According to the present disclosure, correction of the mapping result can be controlled. As a result, the same color across different regions can be prevented from becoming different colors across the regions.

### First Embodiment

The terminology used in the present specification will be defined in advance as follows.

### Color Reproduction Region

“Color reproduction region” may also be referred to as color reproduction range, color gamut, and gamut. Typically, “color reproduction region” refers to a range of colors that is reproducible in a discretionary color space. Also, color gamut volume is used as an index representing the size of the color reproduction region. The color gamut volume is a three-dimensional volume in a discretionary color space. Chromaticity points forming the color reproduction region may be discrete. For example, a specific color reproduction region is represented by 729 points on CIE-L*a*b*, and points between them are obtained by using a known interpolation operation such as tetrahedral interpolation or cubic interpolation. In this case, as the corresponding color gamut volume, it is possible to use a volume obtained by calculating the volumes on CIE-L*a*b* of tetrahedrons or cubes forming the color reproduction region and accumulating the calculated volumes, in accordance with the interpolation operation method. The color reproduction region and the color gamut in the present embodiment are not limited to a specific color space, but in the present embodiment, an example is described in which a color reproduction region in the CIE-L*a*b* space is used. Also, the numerical value of the color reproduction region in the present embodiment indicates the volume obtained by accumulation in the CIE-L*a*b* space based on tetrahedral interpolation.

### Gamut Mapping

Gamut mapping is processing of converting different color gamut spaces and is, for example, mapping of an input color gamut to an output color gamut of a device such as a printer. Perceptual, saturation, colorimetric, and the like of the ICC profile are typical examples. Mapping processing may be implemented via conversion using a three-dimensional look-up table (3D LUT), for example. Also, the mapping processing may be executed after color space conversion into a standard color space. For example, in a case where the input color space is sRGB, the input color space is converted into the CIE-L*a*b* color space, and then processing to map this on an output color gamut in the CIE-L*a*b* color space is executed. Mapping processing may be conversion via a 3D LUT or may using a conversion formula. Also, conversion of the color space at the time of input and the color space at the time of output may be performed simultaneously. For example, at the time of input it may be an sRGB color space, and at the time of output it may be converted to an RGB value of a CMYK value unique to the printer.

### Document Data

Document data refers to the entire input digital data to be processed. The document data includes from one to a plurality of pages. Each single page may be held as image data or may be represented as a drawing command. In a case where the data is represented as a drawing command, the data may be rendered, converted into image data, and then processed. The image data may be formed by a plurality of pixels two-dimensionally arranged. Each pixel holds information indicating a color in the color space. Examples of the information indicating a color are, for example, RGB values, CMYK values, a K value, CIE-L*a*b* values, HSV values, HLS values, and the like. Note that the present embodiment can be applied in the case of one page and in the case of a plurality of pages. The present embodiment will be described using one page of document data as the image data as an example.

### Color Degeneration

In the present embodiment, color degeneration is defined as the distance between colors after mapping in a predetermined color space being less than the distance between colors before mapping when gamut mapping is performed of two discretionary colors. Specifically, in the digital document, there is a color A and a color B, and by performing mapping in the color gamut of the printer, the color A is converted to a color C and the color B is converted to a color D. In this case, color degeneration is defined as the distance between the color C and the color D being less than the distance between the color A and the color B. When there is color degeneration, colors that are recognized as being different in the digital document are recognized as the same color when printed. For example, in a graph, different items are recognized by making different items different colors. When there is color degeneration, there is a possibility of different colors being recognized as the same color and different items in the graph being falsely recognized as the same item. The predetermined color space for calculating the distance between colors here may be a discretionary color space. For example, sRGB color space, Adobe RGB color space, CIE-L*a*b* color space, CIE-LUV color space, XYZ color system color space, xyY color system color space, HSV color space, HLS color space, or the like may be used.

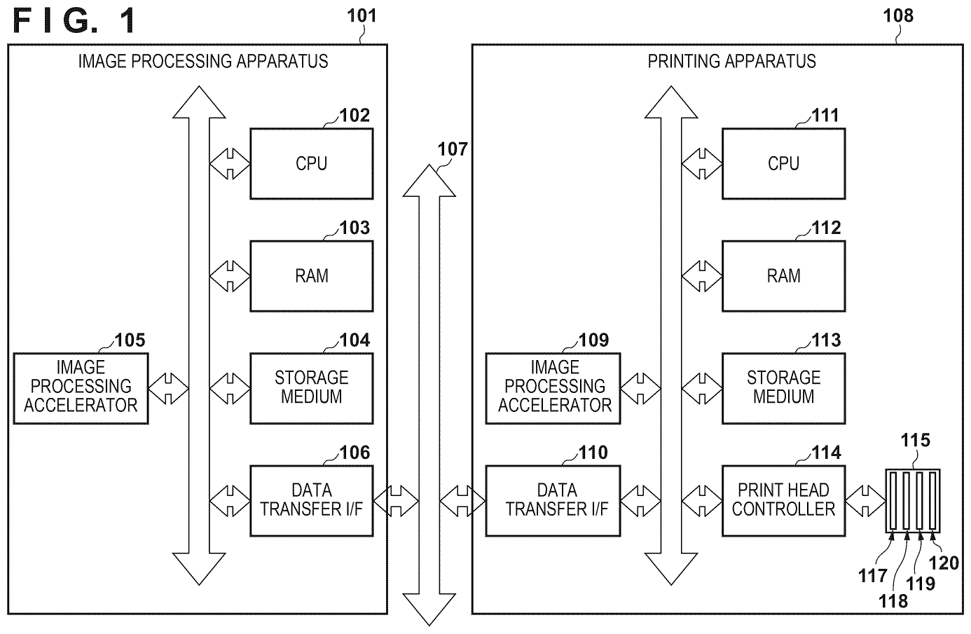

FIG. 1 is a block diagram illustrating an example of the configuration of an image processing apparatus according to the present embodiment. A PC, a tablet, a server, or a printing apparatus may be used as an image processing apparatus 101, for example. FIG. 1 illustrates an example in which the image processing apparatus 101 is configured separate to a printing apparatus 108. A CPU 102 executes various types of image processing by reading out a program stored in a storage medium 104, such as a HDD or a ROM, onto a RAM 103 serving as a working area and executing the program. For example, the CPU 102 obtains a command from a user via a human interface device (HID) I/F (not illustrated). Then, the various types of image processing are executed according to the obtained command and the program stored in the storage medium 104. Also, the CPU 102 executes predetermined processing according to a program stored in the storage medium 104 on document data obtained via a data transfer I/F 106. Then, the CPU 102 displays this result and/or various information on a display (not illustrated) and transmits it as print data via the data transfer I/F 106.

An image processing accelerator 105 is a piece of hardware that can execute image processing at higher speeds than the CPU 102. The image processing accelerator 105 is activated by the CPU 102 writing the parameters and data required for image processing to a predetermined address of the RAM 103. The image processing accelerator 105 executes image processing on the data after the parameters and data described above are loaded. However, the image processing accelerator 105 is not a required component, and similar processing may be executed by the CPU 102. Specifically, an image processing accelerator is a GPU or an exclusively designed electric circuit. The parameters described above may be stored in the storage medium 104 or may be obtained from the outside via the data transfer I/F 106. The image processing apparatus 101 is not limited to the configuration illustrated in FIG. 1 and may have a configuration appropriate for the functions executable by the device used as the image processing apparatus 101.

In the printing apparatus 108, a CPU 111 comprehensively controls the printing apparatus 108 by reading out a program stored in a storage medium 113 onto a RAM 112 serving as the working area and executes the program. An image processing accelerator 109 is a piece of hardware that can execute image processing at higher speeds than the CPU 111. The image processing accelerator 109 is activated by the CPU 111 writing the parameters and data required for image processing to a predetermined address of the RAM 112. The image processing accelerator 109 executes image processing on the data after the parameters and data described above are loaded. However, the image processing accelerator 109 is not a required component, and similar processing may be executed by the CPU 111. The parameters described above may be stored in the storage medium 113 or may be stored in a storage (not illustrated) such as a flash memory, HDD, or the like.

Here, the image processing executed by the CPU 111 or the image processing accelerator 109 will be described. The image processing is processing to generate data indicating dot formation positions of the ink for each scan by a print head 115 on the basis of the obtained print data. The CPU 111 or the image processing accelerator 109 executes color conversion processing on the obtained print data and quantization processing.

Color conversion processing is processing to separate colors by the ink density handled by the printing apparatus 108. For example, the obtained print data includes image data indicating an image. In a case where the image data is data indicating an image in a color space coordinate system such as sRGB as the expression colors of a monitor, data indicating an image by color coordinates (R, G, B) of the sRGB is converted into ink data (CMYK) to be handled by the printing apparatus 108. The color conversion method is implemented by matrix operation processing or processing using a 3D LUT or a 4D LUT.

The printing apparatus 108 according to the present embodiment uses black (K), cyan (C), magenta (M), and yellow (Y) in printing, for example. Thus, image data of an RGB signal is converted into image data including 8-bit color signals for K, C, M, and Y. The color signal of each color corresponds to the applied amount of ink of each color. Also, the number of ink colors in this example is four: K, C, M, and Y. However, to improve image quality, low-density colors such as fluorescent ink (F), light cyan (Lc), light magenta (Lm), and gray (Gy) and other similar ink colors may be used. In this case, color signals corresponding to these inks are generated.

After the color conversion processing, quantization processing is executed on the ink data. The quantization processing is processing to reduce the level numbers of tones in the ink data. In the present embodiment, quantization is performed using a dither matrix including an array of thresholds for comparing ink data values for each pixel. Via quantization, ultimately, binary data indicating whether or not to form a dot at each dot formation position is generated.

After the image processing, the binary data is transferred to the print head 115 by a print head controller 114. The CPU 111 performs print control to run the carriage motor (not illustrated) for operating the print head 115 via the print head controller 114 and to run the conveyance motor for conveying the printing medium simultaneously. The print head 115 scans on the printing medium, and simultaneously, ink droplets are discharged on the printing medium by the print head 115 to form an image.

The image processing apparatus 101 and the printing apparatus 108 are connected via a communication line 107. In the present embodiment, a local area network (LAN) is used as an example of the communication line 107. However, a USB hub, a wireless communication network using a wireless access point, a connection using a WiFi Direct communication function, or the like may be used. Also, apparatuses other than the image processing apparatus 101 and the printing apparatus 108 may be connected to the communication line 107. For example, a host PC may be connected to the communication line 107, and both the image processing apparatus 101 and the printing apparatus 108 may be connected to the host PC in a communication-enabling manner.

In the following examples, the print head 115 includes a nozzle array for four colors of ink: cyan (C), magenta (M), yellow (Y), and black (K).

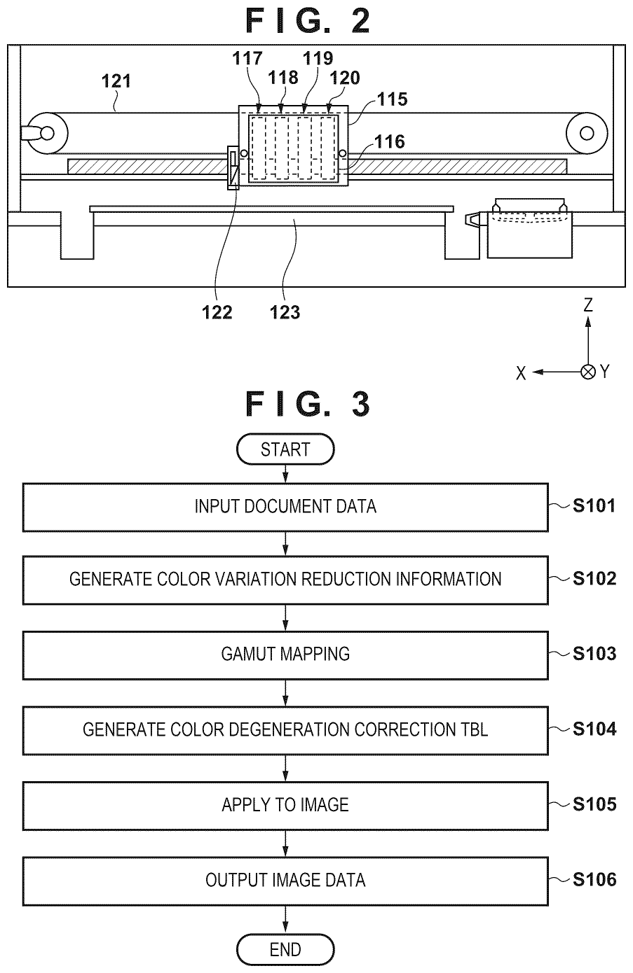

FIG. 2 is a diagram for describing the print head 115 according to the present embodiment. In the present embodiment, an image is printed by performing N number of scans for a unit region corresponding to one nozzle array. The print head 115 includes a carriage 116; nozzle arrays 117 (K), 118 (C), 119 (M), and 120 (Y); and an optical sensor 122. The carriage 116 is installed with the five nozzle arrays 117, 118, 119, and 120 and the optical sensor 122 and can move back and forth in the X direction in the diagram (main scan direction) via the driving force of a carriage motor transferred via a belt 121. The carriage 116 moves in the X direction relative to the printing medium as ink droplets are discharged in the gravity direction (Z direction in the diagram) from each nozzle of the nozzle arrays on the basis of the image data. Accordingly, an image corresponding to 1/N of the main scan is printed on the printing medium placed on a platen 123. When one main scan is complete, the printing medium is conveyed a distance corresponding to the width of 1/N of the main scan in the conveyance direction (−Y direction in the diagram) intersecting the main scan direction. With these operations, an image with a width corresponding to one nozzle array is printed via a plurality of scans corresponding to N times. By alternately repeating the main scan and the conveyance operation, an image is gradually formed on the printing medium. In this manner, control is performed to complete the image printing in the predetermined region.

The print target is a print target for which is important that the tint is the same across different regions such as pages. For example, for a theme color for which the tint is important for design, it is important that a heading, text, and the like are represented with a predetermined color across a plurality of pages. Here, in a case where the same input color exists across different pages and different colors exist on each page, the input color combinations are different across pages. Thus, on each page, gamut mapping is dynamically performed according to the input color, and when color degeneration correction is performed, even if the input color is the same, color variation may occur, creating different colors. In the present embodiment, a color for which it is important that the tint is the same across pages is determined as a color variation reduction target color on the basis of information in the image data. Also, in a case where post-color-degeneration-correction mapping is generated, color degeneration correction is not performed on the color variation reduction target colors and performed on colors that are not color variation reduction target colors. Accordingly, the effects of dynamically performing color degeneration correction can be maintained as much as possible, and an effect of reducing the color variation in a color for which it is important that the tint is the same across pages can be obtained.

### Overall Flow

FIG. 3 is a flowchart illustrating the overall processing of the image processing apparatus 101 according to the present embodiment. In the present embodiment, via the processing of FIG. 3, the distance between colors in a predetermined color space can be increased for color combinations that show color degeneration. As a result, the degree of color degeneration can be reduced. The processing in FIG. 3 is implemented by the CPU 102 reading out a program stored in the storage medium 104 on the RAM 103 and executing the program, for example. Also, the processing of FIG. 3 may be executed by the image processing accelerator 105.

In step S101, the CPU 102 obtains the document data stored in the storage medium 104. Also, the CPU 102 may input the obtained document data via the data transfer I/F 106. Image data including color information is obtained from the input document data. The image data includes, as color information, values indicating colors represented in a predetermined color space. In step S101, the CPU 102 obtains values indicating colors. The values indicating colors may be sRGB data, Adobe RGB data, CIE-L*a*b* data, CIE-LUV data, XYZ color system data, xyY color system data, HSV data, or HLS data, for example.

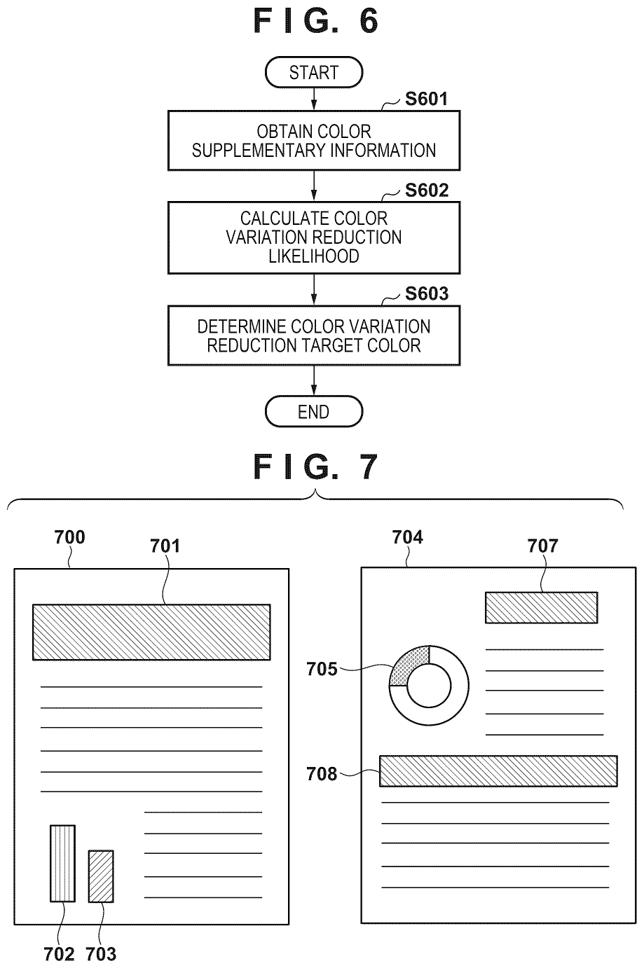

In step S102, the CPU 102 executes processing to generate color variation reduction information. FIG. 6 is a flowchart illustrating the processing of step S102. In step S601, the CPU 102 obtains color supplementary information that supplements each piece of color information of the image data forming the document data obtained in step S101. Specifically, the color supplementary information includes the number of pixels, rectangular region position, sheet surface distribution, and the like, for example. The color variation reduction information is information including color information, color supplementary information, and color variation reduction target color information. A detailed example of color supplementary information will now be described using FIG. 7.

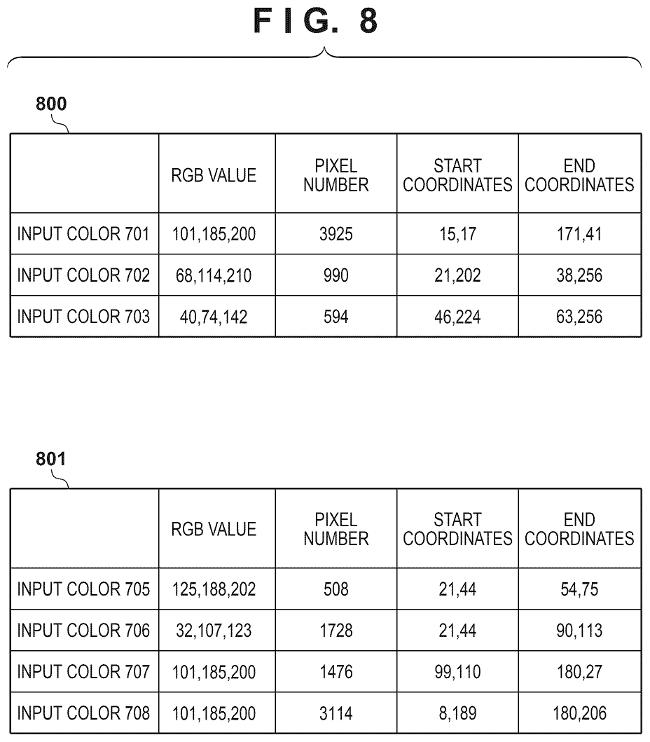

FIG. 7 is a diagram illustrating an example of input document data. FIG. 7 illustrates document data including two pieces of image data, image data 700 and image data 704. Also, FIG. 8 is a diagram illustrating an example of the color supplementary information obtained in step S102. First, the image data 700 will be described. In the image data 700, three inputs colors, an input color 701, an input color 702, and an input color 703, are present. In step S101, the color-representing-values, RGB values for example, of the three input colors are obtained as color information. In step S601, color supplementary information is obtained for each color in the color information obtained in step S101. Color supplementary information 800 of FIG. 8 illustrates the color supplementary information obtained from the image data 700 as an example. RGB value is the values representing a color. Pixel number is the number of pixels corresponding to each input color in the image data. Start coordinates are the coordinates of the upper-left end point in the case of representing the position where each input color is present is represented as a rectangular region and End coordinates are the coordinates of the lower-right end point. Note that here, the upper-left end point of the entire region in the image data is set as the origin.

In step S602, the CPU 102 calculates the likelihood for determining the color variation reduction target color on the basis of the color supplementary information obtained in step S601. In the present embodiment, this likelihood is referred to as in-page likelihood. First, the color variation reduction target color is a color determined to not be a target of color degeneration correction (or reduction) due to it being important that the tint is the same across pages. An example of a color for which it is important that the tint is the same across pages includes a theme color on a document with the heading, text, or the like being made of a certain color in a design or template that is the same across a plurality of pages. Also, such a color typically have characteristics including, in the color supplementary information obtained in step S601, having a large proportion of pixel numbers relative to the entire pixel number of the sheet surface, having a large rectangular region size representing its location, and being located at an end in the region representing the image data. In the present embodiment, such characteristics are used as criteria for selecting the color variation reduction target color. The in-page likelihood is calculated for each input color from the color supplementary information.

An example of calculating the in-page likelihood will now be described. The in-page likelihood is calculated by combining a plurality of values. In the present embodiment, for example, the in-page likelihood is calculated by combining three values, a value calculated using the pixel number, a value calculated using the rectangular region size, and a value calculated using its location.

The value calculated using the pixel number is the proportion of the number of pixels of the input color relative to the maximum number of pixels of the image data. At this time, a threshold is set, and if the proportion taken up in the print region is less than the threshold, the value may be set to zero. The print region is a region corresponding to the size of the sheet where the image data is to be printed.

The value calculated using the rectangular region size is the proportion of the rectangular region where the input color is present relative to the maximum rectangular size of the image data. The size of the rectangular region where the input color is present is obtained from the color supplementary information. Here also, a threshold is set, and if the proportion taken up in the print region is less than the threshold, the value may be set to zero. The maximum rectangular size is the size of the sheet where the image data is to be printed, for example.

The value calculated using the location is described below and is a value calculated on the basis of whether or not the rectangular region where the input color is present is located in a region (sheet end region) represented by a threshold in the print region.

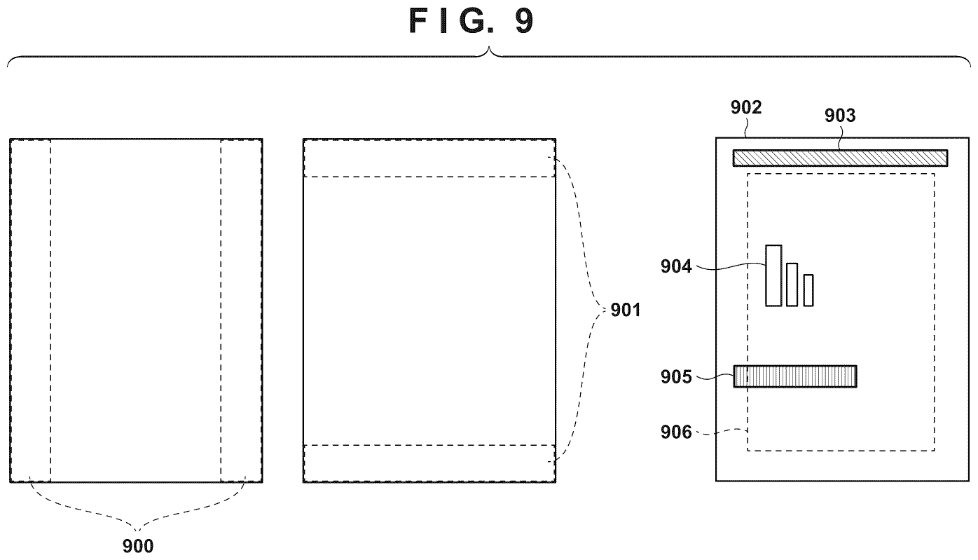

FIG. 9 is a diagram for describing processing to determine how much the start coordinates and the end coordinates of the rectangular region where the input color is present are located overlapping a region represented by a threshold. A region 900 is a region defined as a sheet end region in the X coordinate direction in the image data. Also, a region 901 is a region defined as a sheet end region in the Y coordinate direction in the image data. It is determined whether or not the X coordinate and the Y coordinate of the start coordinates of the rectangular region where the input color is present and the X coordinate and the Y coordinate of the end coordinates belong in these regions. If they do belong, 0.5 is added, and the added total value is used in calculating the in-page likelihood.

Image data 902 will now be described as an example. A broken line 906 is not in the image data and is a sheet end region defined to facilitate description. Outside of the broken line is the paper end region. An input color 903 has the X coordinate and the Y coordinate of the start coordinates and the X coordinate and the Y coordinate of the end coordinates of the rectangular region where the input color is present all belonging in the paper end region. Thus, the total value is 0.5+0.5+0.5+0.5=2.0. An input color 904 has the X coordinate and the Y coordinate of the start coordinates and the X coordinate and the Y coordinate of the end coordinates of the rectangular region where the input color is present all not belonging in the paper end region. Thus, the total value is 0. An input color 905 has the X coordinate of the start coordinates of the rectangular region where the input color is present belonging in the paper end region and the Y coordinate not belonging in the paper end region. Also, the end coordinates both do not belong in the paper end region. Thus, the total value is 0.5.

The in-page likelihood relating to the input color is obtained by multiplying the three types of values obtained by the calculations up until here. At this time, in a case where a plurality of input colors with the same RGB values are present, the in-page likelihood may be calculated from the merging of color information, or the in-page likelihood may be calculated after the separate calculations. Also, instead of multiplying the values, the values may be added and weight may be added.

In step S603, the CPU 102 determines the color variation reduction target color on the basis of the in-page likelihood for each input color obtained in step S602. In the present embodiment, the color with the highest in-page likelihood is set as the color variation reduction target color. A plurality of color variation reduction target colors may be selected or one may be determined on the basis of a priority order. Also, depending on how the value for the threshold is set, there may be a case where only input colors with an in-page likelihood of 0 are present. In such a case, no determination may be performed and no color variation reduction target color may be set. The CPU 102 stores information indicating, of the input colors, what color is the color variation reduction target color, in the RAM 103 or the storage medium 104. After the processing described above is completed, the processing of FIG. 6 ends, and the processing proceeds to step S103.

In step S103, the CPU 102 uses the color conversion information pre-stored in the storage medium 104 to perform color conversion (gamut mapping) on the image data. The color conversion information according to the present embodiment is specifically, for example, a gamut mapping table, and gamut mapping is performed on the color information of each pixel of the image data. The post-gamut-mapping image data is stored in the RAM 103 or the storage medium 104. Specifically, for example, the gamut mapping table is a three-dimensional look-up table (3D LUT). Combinations of output pixel values (Rout, Gout, and Bout) are calculated for combinations of input pixel values (Rin, Gin, and Bin) using the three-dimensional look-up table. In a case where the input values Rin, Gin, and Bin each have 256 tones, for example, a table 1 [256][256][256][3] is used with a total of 16777216 (256×256×256) combinations of output values. Color conversion is performed using the gamut mapping table. Specifically, for example, the processing of Formulas (1) to (3) is executed on each pixel of an image formed with RGB pixel values of the image data obtained from the document data input in step S101.

$$Rout = Table 1 [ Rin ] [ Gin ] [ Bin ] [ 0 ] \qquad ( 1 )$$

$$Gout = Table 1 [ Rin ] [ Gin ] [ Bin ] [ 1 ] \qquad ( 2 )$$

$$Bout = Table 1 [ Rin ] [ Gin ] [ Bin ] [ 2 ] \qquad ( 3 )$$

Also, the look-up table grid number may be reduced from 256 grids to 16 grids, for example, and the table values of a plurality of grids may be interpolated to determine output values to reduce the table size, for example.

In step S104, the CPU 102 generates a post-color-degeneration-correction table on the basis of the following information.
The image data obtained in step S101
   The image data after the gamut mapping performed in step S103
   The gamut mapping table used in step S103
   The information of the color variation reduction target color set in step S102

The format of the post-color-degeneration-correction table is similar to the format of the gamut mapping table. The processing to generate the post-color-degeneration-correction table of step S104 will be described below.

In step S105, the CPU 102 uses the post-color-degeneration-correction table generated in step S104 and computes this with the image data obtained in step S101 to generate post-correction image data for which color degeneration correction has been performed. The generated post-correction image data is stored in the RAM 103 or the storage medium 104.

In step S106, the CPU 102 outputs the post-correction image data stored in step S105 from the image processing apparatus 101 to the printing apparatus 108 via the data transfer I/F 106. Thereafter, the processing of FIG. 3 ends.

The gamut mapping used in step S103 may be mapping from an sRGB color space to the color reproduction color gamut of the printing apparatus 108. In this case, a reduction in the chroma and color difference caused by gamut mapping into the color reproduction color gamut of the printing apparatus 108 can be suppressed. Also, the gamut mapping may be color gamut reduction mapping from an sRGB color space to the color reproduction color gamut of the printing apparatus 108, focusing on tone reproduction. In color gamut reduction mapping, the white point and the black point of the sRGB color space are mapped to the white point and the black point of the color reproduction color gamut of the printing apparatus 108, respectively. Also, other colors are converted so that the correlation between the white point and the black point is maintained. Conversion is performed by compressing the chroma in the color direction so that the entire sRGB color space fits within the color reproduction color gamut of the printing apparatus 108.

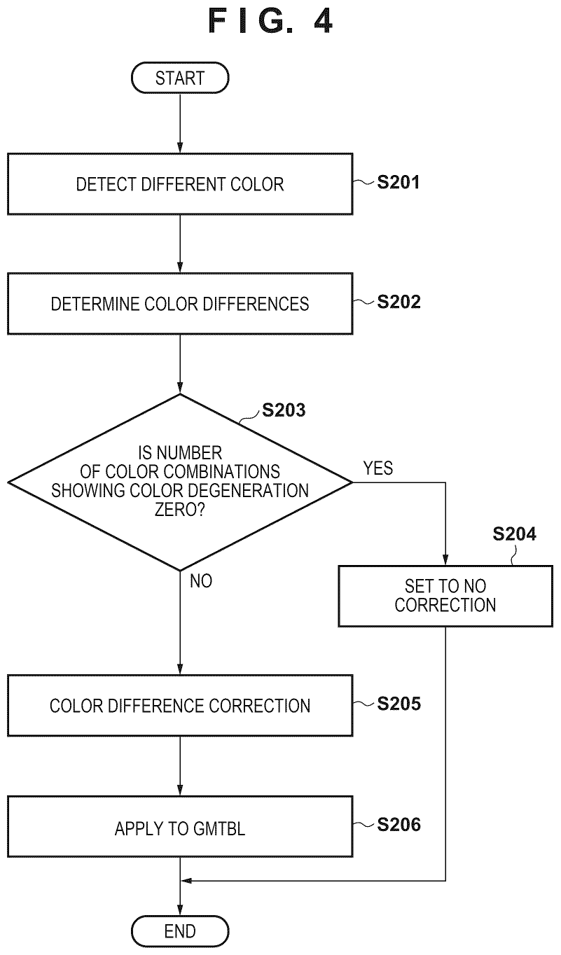

The processing to generate the post-color-degeneration-correction table of step S104 will now be described using FIG. 4. The processing in FIG. 4 is implemented by the CPU 102 reading out a program stored in the storage medium 104 on the RAM 103 and executing the program, for example. Also, the processing of FIG. 4 may be executed by the image processing accelerator 105.

In step S201, the CPU 102 detects a unique color for color degeneration correction from the image data obtained in step S101 (unique color detection processing). The detection result is stored in the RAM 103 or the storage medium 104 as a unique color list. The unique color list is initialized at the start of step S201. The detection processing is repeated for each pixel of the image data and whether or not the color of each pixel is a color different from the unique color detected up until then is determined for all of the pixels included in the image data. In a case where it is determined to be a unique color, it is stored in the unique color list as a unique color.

The determination method includes determining whether or not the color of the target pixel is a color included in the unique color list and, in a case where it is not included, newly adding the color information to the unique color list. In this manner, a list of unique colors included in the image data can be generated. As described above, in a case where the input image data is sRGB data, since there are 256 tones, unique colors are detected from a total of 16777216 (256×256×256) colors. In this case, the color number is expanded and the processing speed is reduced. Thus, unique colors may be detected discretely. For example, unique colors may be detected after colors are reduced from 256 tones to 16 tones. In the case of color reduction, colors are reduced to the color of the closest grid. In this manner, for example unique colors can be detected from a total of 4096 (16×16×16) colors, and the processing speed can be improved.

In step S202, the CPU 102 detects the number color combinations showing color degeneration from among the combinations of unique colors included in the image data on the basis of the list of unique colors detected in step S201.

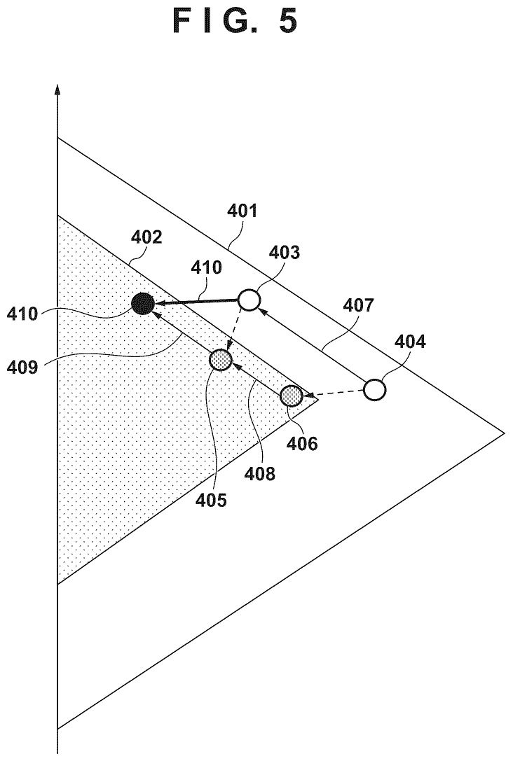

Detecting the number of color combinations showing color degeneration will now be described using FIG. 5. A color gamut 401 is the color gamut of the input image data. A color gamut 402 is the color gamut after gamut mapping in step S103. A color 403 and a color 404 are colors included in the input image data. A color 405 is a color after gamut mapping is performed on the color 403. A color 406 is a color after gamut mapping is performed on the color 404. Here, in a case where a color difference 408 between the color 405 and the color 406 is less than a predetermined color difference, color degeneration is determined. In the present embodiment, in a case where the color difference ΔE408 between the color 405 and the color 406 is less than a color difference ΔE407 between the color 403 and the color 404, color degeneration is determined. The determination processing is repeated a number of times corresponding to the number of combinations of colors in the unique color list. The method of calculating the color difference may include using the Euclidean distance in a color space. A preferred example according to the present embodiment in which the Euclidean distance in a CIE-L*a*b* color space (hereinafter referred to as the color difference ΔE) is used will now be described. Since the CIE-L*a*b* color space is a perceptually uniform color space, the Euclidean distance can be approximately correspond to the color change amount. Thus, when the Euclidean distance in the CIE-L*a*b* color space is small, a person perceives colors as being close to one another, and when large, a person perceives colors as being far away from one another. The color information in a CIE-L*a*b* color space is represented by the color space of the three axes, L*, a*, and b *. For example, the color 403 is represented by L403, a403, and b403. The color 404 is represented by L404, a404, and b404. The color 405 is represented by L405, a405, and b405. The color 406 is represented by L406, a406, and b406. In a case where the input image data is represented in another color space, a known technique is used to convert the data into a CIE-L*a*b* color space. A color difference ΔE407 and a color difference ΔE408 are calculated using Formulas (4) and (5).

$$Δ {E}_{407} = \sqrt{{( {L}_{403} - {L}_{404} )}^{2} + {( {a}_{403} - {a}_{404} )}^{2} + {( {b}_{403} - {b}_{404} )}^{2}} \qquad ( 4 )$$

$$Δ {E}_{408} = \sqrt{{( {L}_{405} - {L}_{406} )}^{2} + {( {a}_{405} - {a}_{406} )}^{2} + {( {b}_{405} - {b}_{406} )}^{2}} \qquad ( 5 )$$

In a case where the color difference ΔE408 is less than the color difference ΔE407, color degeneration is determined. Also, in a case where the color difference ΔE408 is not large enough to be able to identify the color difference, color degeneration may be determined. This is because if the color 405 and the color 406 have a color difference that allows human visual characteristics to identify them as different colors, color difference correction can be determined to be unnecessary. Based on visual characteristics, a color difference ΔE at which different colors can be identified is 2.0, for example. In other words, in a case where the color difference ΔE408 is less than the color difference ΔE407 and the color difference ΔE408 is less than 2.0, color degeneration may be determined.

In step S203, the CPU 102 determines whether or not the number of color combinations showing color degeneration in step S202 is zero. In a case where the number of color combinations showing color degeneration is determined to be zero, the processing proceeds to step S204, and the image data is determined to not require color degeneration correction. Thereafter, the processing of FIG. 4 ends. On the other hand, in a case where the number of color combinations showing color degeneration is determined to be not zero, the processing proceeds to step S205.

When color degeneration correction is performed, the color is changed (color variation). Unnecessary color changes may be caused when the color is also changed for combinations of colors that do not show color degeneration. Thus, the need for color degeneration correction may be determined on the basis of the total number of combinations of unique colors and the number of color combinations showing color degeneration. Specifically, for example, in a case where the number of combinations of colors showing color degeneration is the majority in the total number of combinations of unique colors, it may be determined that color degeneration correction is required. In this manner, the negative effects of color change due to color degeneration correction can be reduced.

In step S205, the CPU 102 performs color degeneration correction on the color combination showing color degeneration on the basis of the input image data, the post-gamut-mapping image data, and the gamut mapping table.

The color degeneration correction will now be described using FIG. 5. The color 403 and the color 404 are colors included in the input image data. The color 405 is a color (post-conversion color) obtained after color conversion is performed on the color 403 via gamut mapping. The color 406 is a color obtained by color conversion of the color 404 via gamut mapping.

FIG. 5 illustrates color degeneration relating to the color combination of the color 403 and the color 404. By separating the distance between the color 405 and the color 406, the color degeneration can be corrected. Specifically, for example, correction processing is executed to increase the distance between the color 405 and the color 406 to a distance equal to or greater than a distance at which the different colors can be identified by a person on the basis of their visual characteristics. Based on the visual characteristics, the distance between colors at which different colors can be identified corresponds to 2.0 or greater for the color difference ΔE. More preferably, the color difference is approximately equal to the color difference ΔE407 between the color 405 and the color 406. The color degeneration correction processing is repeated a number of times corresponding to the number of color combinations showing color degeneration. The result of the color degeneration correction is stored as a table with the pre-correction color information and post-correction color information associated together. In FIG. 5, the color information is color information in a CIE-L*a*b* color space. Thus, the information may be converted into the color space of the input image data and the output image data. In this case, the pre-correction color information in the color space of the input image data and the post-correction color information in the color space of the output image data are associated together and stored as a table.

Next, color degeneration correction processing will be described. A color difference correction amount 409 for spreading out the color difference ΔE from the color difference ΔE408 is obtained. Since the color difference ΔE that allows different colors to be perceived based on visual characteristics is 2.0, the difference between the color difference ΔE2.0 and the color difference ΔE408 (2.0−ΔE408) is the color difference correction amount 409. Alternatively, to retain the color difference of the input image data, the difference between the color difference ΔE407 and the color difference ΔE408 may be the color difference correction amount 409. The result of correcting the color 405 by the color difference correction amount 409 on an extension line of the color 405 from the color 406 in the CIE-L*a*b* color space is a color 410. The color 410 is separated from the color 406 in terms of color difference by the color difference ΔE408 and the color difference correction amount 409 added together. In the foregoing, the extension line of the color 405 from the color 406 is used, but the present embodiment is not limited thereto. As long as the color difference ΔE between the color 406 and the color 410 is a distance in terms of color difference corresponding to the color difference ΔE408 and the color difference correction amount 409 added together, in the CIE-L*a*b* color space, any direction of the lightness direction, the chroma direction, and the hue angle direction may be used. Also, instead of one direction, any combination of the lightness direction, the chroma direction, and the hue angle direction may be used. Furthermore, in the foregoing, the color degeneration is corrected by changing the color 405. However, it may be the color 406 which is changed. Also, both the color 405 and the color 406 may be moved. In the case of changing the color 406, since the color 406 cannot be changed to outside of the color gamut 402, the color 406 is moved along the boundary plane of the color gamut 402. Then, for the remaining color difference ΔE amount, the color 405 is changed to perform color degeneration correction.

In the case described above, neither the color 403 nor the color 404 are the color variation reduction target color. However, in a case where either the color 403 or the color 404 is the color variation reduction target color set in step S102 of FIG. 3, in the color degeneration correction processing described above, the following two items of correction control processing are executed.

In the color degeneration correction, correction of the color variation reduction target color is not performed.

In the color degeneration correction, a color that is not the color variation reduction target color is corrected.

This can prevent color variation of color variation reduction target color occurring at the time of color degeneration correction. In the present embodiment, the two items of processing described above may be referred to as color variation reduction processing. In this case, instead of not correcting the color variation reduction target color at all, by restricting the correction amount to a predetermined range, the change in color may be kept within a range that is imperceivable for human perception. In the present embodiment, color degeneration can be reduced in an image, formed by a color that is not the color variation reduction target color, that is adjacent to or near the image formed by the color variation reduction target color. In other words, color degeneration where a sufficient color difference is present at the time of input image data but the color difference is made insufficient as a result of the gamut mapping processing can be reduced. In addition for the color variation reduction target color, color degeneration correction is not performed (or is restrict), allowing prevention of a color change not expected by the user.

In step S206, the CPU 102 generates a post-color-degeneration-correction table by changing the gamut mapping table (GMTBL) using the result of the color degeneration correction of step S205. The pre-change gamut mapping table is a table for changing the input color, the color 403, to the output color, the color 405. By using the result of the color degeneration correction of step S205 to change the table to convert the input color, the color 403, to the output color, the color 410, a post-color-degeneration-correction table is generated. Accordingly, a post-color-degeneration-correction table can be generated. The gamut mapping table described above is repeatedly changed a number of times corresponding to the number of color combinations showing color degeneration.

As described above, by applying the post-color-degeneration-correction table to the input image data, the distance between colors can be increased for the color combinations in the input image data that show color degeneration. As a result, color degeneration can be reduced in color combinations that show color degeneration. Color degeneration occurs with known gamut mapping because, in a case where the input image data is sRGB data, the gamut mapping table is generated on the premise that all of the input color space, that is the input image data, includes 16777216 colors. A gamut mapping table generated on the basis of this premise takes into account the tone and chroma of colors that are not included in the input image data. In the present embodiment, colors included in the input image data are detected, and a gamut mapping table that is restricted to only colors included in the input image data can be generated. As a result, gamut mapping can be adaptively performed on input image data, allowing color degeneration to be appropriately reduced. Furthermore, in a case where the same color appears across unit regions such as pages, the color is detected as a color variation reduction target color. Then, when the distance between colors is increased to reduce color degeneration, a change relating to the color variation reduction target color is suppressed. Accordingly, the same color present across unit regions being perceived as different colors can be prevented.

In addition, by determining the color variation reduction target color on the basis of the in-page likelihood calculated for each input color of the image data, even with different pieces of image data, the result of color degeneration correction of the same color can be made to match. As a result, color variation in the same color across different pieces of image data can be suppressed, and the color degeneration reduction result can be maintained as much as possible for other colors. For example, as a result of executing the processing of FIG. 3 on the image data 700 of FIG. 7, the input color 701 is made the color variation reduction target color, and as a result of executing the processing of FIG. 3 on the image data 704 of FIG. 7, the input colors 707 and 708 are made the color variation reduction target color. In this case, the input colors 701, 707, and 708 are all the same color, and the color degeneration correction result is the same. On the other hand, for other input colors, the color difference in each piece of image data is expanded by the color degeneration correction described above. Thus, the effect of the color degeneration correction is maintained.

In the present embodiment, the post-color-degeneration-correction gamut mapping table is applied to the input image data. However, a correction table for performing color degeneration correction on post-gamut-mapping image data may be generated. In this case, on the basis of the result of the color degeneration correction in step S205, a correction table for converting from pre-correction color information to post-correction color information may be generated. The generated correction table is a table for converting from the color 405 to the color 410 as illustrated in FIG. 5. In step S105, the generated correction table is applied to the post-gamut-mapping image data. As described above, the degree of color degeneration caused by gamut mapping can be reduced even by correcting post-gamut-mapping image data.

In the present embodiment, processing for suppressing color variation caused by color degeneration correction has been described. A post-color-degeneration-correction table may be dynamically generated via a different method to that of the present embodiment. As described above, when a color variation reduction target color is determined in step S102 and a post-color-degeneration-correction table is generated according to the input color, color degeneration correction of the color variation reduction target color is suppressed. As a result, the effect obtained as a result of dynamically performing color degeneration correction on the image data can be maintained as much as possible, and an effect of reducing the color variation in a color for which it is important that the tint is the same across pages can be obtained.

### Second Embodiment

The differences between the second embodiment and the first embodiment will be described below. In the first embodiment, color supplementary information is obtained for each piece of image data, the in-page likelihood is calculated on the basis of the color supplementary information, and the color variation reduction target color is determined. Here, for example, consider the case of document data in which a theme color is present at a common position in all of the pages, but there is also another input color on a specific page with a size greater than that. At this time, depending on the in-page likelihood calculation result, the theme color may not be determined as the color variation reduction target color for only the specific page. Here, in the present embodiment, when processing of the document data is executed, the color information, the color supplementary information, and the color variation reduction target color information are carried over across pages. Thus, on the basis of not only the characteristics of each page but also common characteristics across pages, the color variation reduction target color can be determined.

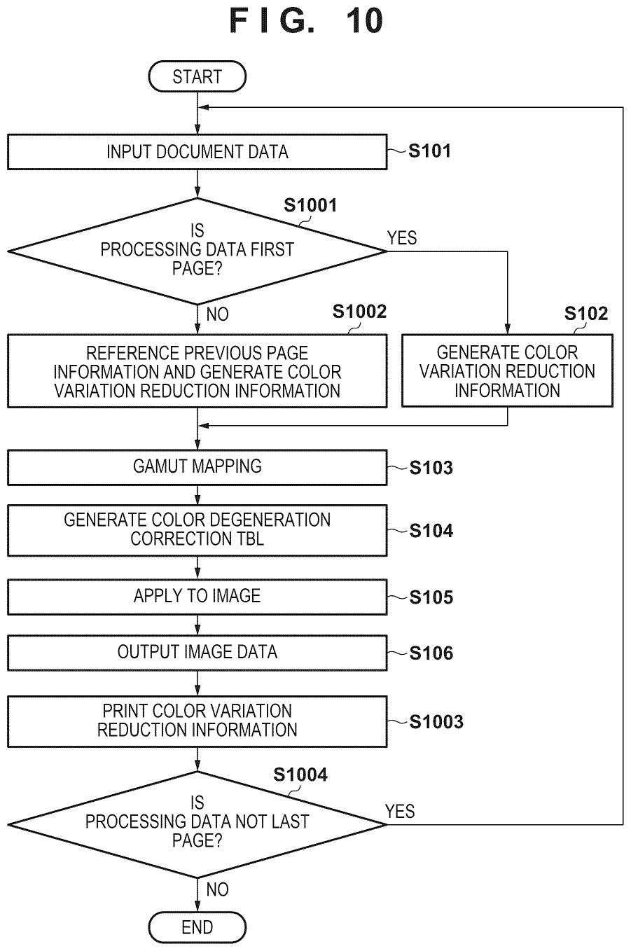

FIG. 10 is a flowchart illustrating the overall processing of the image processing apparatus 101. The processing in FIG. 10 is implemented by the CPU 102 reading out a program stored in the storage medium 104 on the RAM 103 and executing the program, for example. Also, the processing of FIG. 10 may be executed by the image processing accelerator 105. Note that for the step numbers that are the same as in FIG. 3, the steps are the same as the steps in FIG. 3, and descriptions thereof are omitted.

After step S101, in step S1001, the CPU 102 determines whether or not the image data obtained in step S101 is the first page of the document that includes a plurality of pages. In a case where it is determined to be the first page, the processing proceeds to step S102. In a case where it is determined to not be the first page, the processing proceeds to step S1002.

In step S1002, the CPU 102 references the color variation reduction information of the previous page (described below) and determines the color variation reduction target color. The processing of step S1002 is described below and, in the present embodiment, includes obtaining the common characteristic across pages by referencing the color variation reduction information of the previous page and not just the characteristic of the page currently targeted. Then, the color variation reduction target color is determined on the basis of both characteristics.

When the color variation reduction target color is determined via the processing of step S102 or step S1002, in steps S103 to S106, similar processing to that in the first embodiment is executed. Step S1003 follows step S106.

In step S1003, the CPU 102 stores the color information of the page currently being processed, the color supplementary information, and the color variation reduction target color information in the RAM 103 or the storage medium 104. Specifically, for example, as a result of the processing up to step S106 being executed on the image data 700 of FIG. 7, the input color 701 is determined as the color variation reduction target color. In this case, the RGB values of the input color 701, the input color 702, and the input color 703 indicated in the color supplementary information 800; the color supplementary information; and information indicating that the input color 701 is the color variation reduction target color are stored in step S1003.

In the present embodiment, in step S1003, the information of the page currently being processed as well as the information of the previous page may be carried over and stored. Specifically, for example, the pixel number included in the color supplementary information of the page currently being processed remains unchanged and the pixel number included in the color supplementary information of the previous page decreases by 0.5 times and these are stored as the color supplementary information 800. At this time, in a case where the pixel number is equal to or less than a certain value, the color information may be deleted from the color supplementary information 800. In other words, for the page currently being processed, the weight of the color information of the image data with a short distance between pages is increased and the weight of the color information of the image data with a long distance between pages is decreased to adjust the list of color supplementary information represented by the color supplementary information 800 in step S1003. Accordingly, a color that appears throughout all of the pages remains in the color supplementary information 800, but a color that appears only on one specific page decreases in pixel number before ultimately disappearing from the color supplementary information 800. Accordingly, a color that appears throughout all of the pages is applied with an across-page likelihood described below and is made easier to be determined as the color variation reduction target color. As described above, the pixel number decreases by 0.5 times. However, the pixel number may be merged with that of the color supplementary information of the previous page to find an average. For example, an average value with the pixel number of the previous page may be calculated. Accordingly, the pixel number of a color present across pages does not decrease, and the pixel number of a color not present across pages decreased by half. Accordingly, a color present across pages remains in the color supplementary information 800, is applied with an across-page likelihood, and is made easier to be determined as the color variation reduction target color. On the other hand, if the pixel number of a color that is not present after a certain page is continuously halved and reaches a value equal to or less than a threshold, the color ultimately disappears from the color supplementary information 800. Accordingly, compared to a color that does not appear after a certain page, a color that appears across pages is applied with an across-page likelihood and is made easier to be determined as the color variation reduction target color. In the example described above, pixel number is used. However, instead of pixel number, a value obtained from the color supplementary information including the size, position, or the like of a rectangular region may be used. Also, the calculated likelihood value may be used.

The information up until the previous page may be not stored (reset). The reset timing may be when the image data to be processed is the first page, when there is a blank page, or when the current page is monochrome. Also, the timing is not limited to the page number or a division of the data to be processed, and a certain amount of time passing may be used. Alternatively, these conditions may be used in combination. The information to be stored may be only the color information. Also, a histogram with the same units as the grid units of the 3D LUT may be generated, and the color supplementary information may be stored in the histogram. In the case of executing 3D LUT processing for the mapping processing, in the obtained color supplementary information, even if there are different values for the values representing colors such as RGB values or the like, in the 3D LUT grid, they are the same. Since the unit for which color variation reduction and color degeneration correction are ultimately performed is a 3D LUT grid unit, the color supplementary information is handled using the same unit and the likelihood is calculated, allowing for a more suitable color variation reduction processing to be executed. An example of the method for converting to histogram grid units for the color supplementary information includes, for example, totaling the pixel numbers and, when calculating the rectangular region size, using the coordinates of the furthest end portion from among the end portions.

Next, in step S1004, the CPU 102 determines whether or not the data currently being processed is the last page of the document data. In a case where it is determined to not be the last page, the processing returns to step S101 and processing of the next page is executed. In a case where it is determined to be the last page, the processing of FIG. 10 ends.

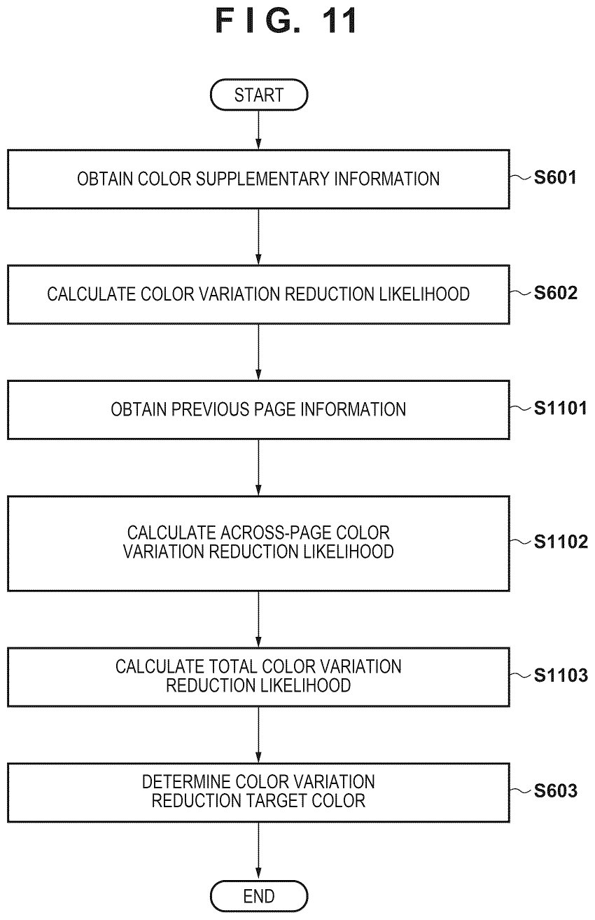

The processing of step S1002 will now be described. FIG. 11 is a flowchart illustrating the processing of step S1002. Note that for the step numbers that are the same as in FIG. 6, the steps are the same as the steps in FIG. 6, and descriptions thereof are omitted. Step S1101 follows steps S601 and S602.

In step S1101, the CPU 102 obtains the color variation reduction information of the previous page. Obtained here is information including the color information, color supplementary information, and color variation reduction target color information of the previous page for which image data has been stored in the RAM 103 or the storage medium 104 in step S1003 when the processing of FIG. 10 is executed on the page before the page currently being processed, subjected to color correction processing, and output. Next, in step S1102, the CPU 102 calculates the across-page likelihood on the basis of the color supplementary information obtained in step S601 and the color variation reduction information of the previous page obtained in step S1101.

Here, the across-page likelihood is a value for obtaining a characteristic of a color for which it is important that the tint is the same across pages that cannot be obtained with the in-page likelihood described in the first embodiment. An example of this characteristic includes the same color being present at the same position across a plurality of pages and the shape of a rectangular region where the color is present being similar. The across-page likelihood is calculated by obtaining such a characteristic from the color supplementary information and combining a plurality of values. In the present embodiment, the across-page likelihood is calculated by combining three values, a value calculated using a location, a value calculated using the shape similarity, and a value calculated on the basis of whether the color is retained from the previous page.

Also, the across-page likelihood is calculated only in a case where it is determined that, between the page currently being processed and the previous page, the color information is the same or the colors are very similar and are determined to be the same. In other words, for colors not determined to be the same between the page currently being processed and the previous page, the across-page likelihood is not calculated and is set to 0. Also, as described above, for color information of which the pixel number is continuously decreased and then deleted from the list and not stored in step S1003, the across-page likelihood is also not calculated and set to 0.

The value calculated on the basis of location is a value obtained on the basis of the result of comparing the start position and the end position of a rectangular region where the input color is present between the previous page and the page currently being processed. Specifically, for example, in a case where the positions of the rectangular regions overlap, the value is set to 1.0, and in other cases, the value is set to 0. Here, the overlap area may be calculated as a calculation of the continuous value.

The value calculated on the basis of shape similarity is a value obtained on the basis of the result of comparing the shape of a rectangular region where the input color is present between the previous page and the page currently being processed. Specifically, for example, for both the previous page and the page currently being processed, the aspect ratio of the rectangular region is calculated, and the smaller value is divided by the larger. Next, for both the previous page and the page currently being processed, the length of the rectangular region in the X-axis direction and the Y-axis direction are calculated, and for both the length in the X-axis direction and the length in the Y-axis direction, the smaller value is divided by the larger. This is because the maximum value is set to 1.0 when dividing by the larger value. Then, these three values are multiplied to obtain a value calculated via shape similarity. In a case where the three values match between the previous page and the page currently being processed, the values correspond to 1.0×1.0×1.0=1.0.

The value calculated on the basis of whether the color is retained from the previous page is a value obtained on the basis of whether or not the color targeted in the page currently being processed was the color variation reduction target color for the previous page. In a case where the color was the color variation reduction target color, the value is set to 1.0, otherwise, the value is set to 0.

The across-page likelihood relating to the input color is obtained by adding the three types of values obtained by the calculations up until here. At this time, in a case where a plurality of input colors with the same RGB values are present, the across-page likelihood may be calculated from the merging of color information, or the across-page likelihood may be calculated after the separate calculations. Also, instead of adding the values, the values may be multiplied and weight may be added.

In step S1103, the CPU 102 calculates the total likelihood on the basis of the in-page likelihood and the across-page likelihood for each input color obtained in steps S602 and S1102. Here, the two values may be added together or multiplied. Also, weight may be added when they are added together.

After step S1103, in step S603, the CPU 102 determines the color variation reduction target color on the basis of the total likelihood of each input color obtained in step S1103. In the present embodiment, the color with the highest total likelihood is set as the color variation reduction target color. A plurality of color variation reduction target colors may be determined or one may be determined on the basis of a priority order. Also, depending on how the value for the threshold is set, there may be a case where only input colors with a total likelihood of 0 are present. In such a case, no determination is performed and no color variation reduction target color is set. Information indicating, of the input colors, what color is the color variation reduction target color is stored in the RAM 103 or the storage medium 104. After step S603, the processing of FIG. 11 ends, and the processing proceeds to step S103 of FIG. 10.

Via the processing described above, in addition to the in-page likelihood described in the first embodiment, the across-page likelihood is also calculated, the color variation reduction target color is determined on the basis of these likelihoods, and color variation reduction processing is executed. As a result, even with different pieces of image data, a color with the same characteristic, for example, a color with the characteristic of being common across pages, is made easier to be determined the color variation reduction target color, and the result of the color degeneration correction is made the same. As a result, color variation in the same color at input across different pieces of image data can be suppressed, and the color degeneration reduction result can be maintained as much as possible for other colors.

In the present embodiment, from different pieces of data (that is, previous pages) in the document data that have already been subjected to color correction processing and that have image data output, the color supplementary information is carried over, and processing to store the color variation reduction information in step S1003 is executed. Here, the image data with confirmed information for color degeneration correction may be set as the target for obtaining color supplementary information as a separate flow to steps S105 and S106. Also, different pieces of image data in the document data not subjected to color degeneration correction may not be targeted for obtaining color supplementary information. Also, image data in different pieces of document data may be targeted for obtaining color supplementary information. Also, a combination of these may be used. By obtaining the color supplementary information from also different pieces of image data not subjected to color degeneration correction, a color commonly used in document data is made easier to be determined at the color variation reduction target color. Also, since the color supplementary information is obtained from the image data in different pieces of document data, color variation in the same color at input even across different pieces of document data can be suppressed, and the color degeneration reduction result can be maintained as much as possible for other colors.

In the processing described above, both the in-page likelihood and the across-page likelihood are used to determine the color variation reduction target color and color variation of the same color at input is suppressed. Here, since processing is executed to not obtain color supplementary information and not determine a color variation reduction target color, the color information of a previous page can be carried over, allowing color variation of the same color at input to be suppressed.

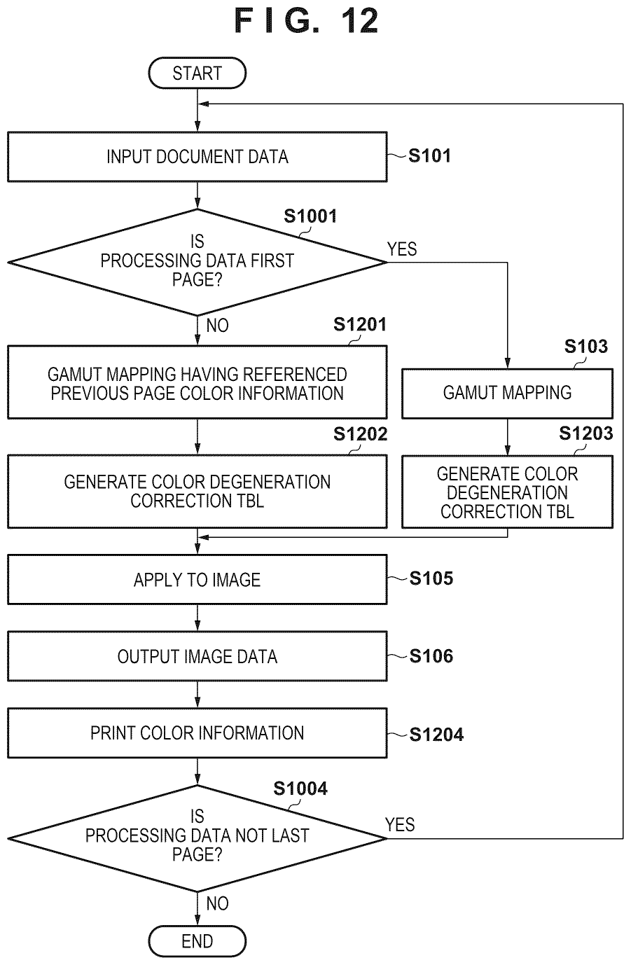

FIG. 12 is another flowchart illustrating the overall processing of the image processing apparatus 101. Note that for the step numbers that are the same as in FIG. 10, the steps are the same as the steps in FIG. 10, and descriptions thereof are omitted. After step S101, the determination of step S1001 is performed. In step S1001, in a case where it is determined that the image data obtained in step S101 is the first page of a document that includes a plurality of pages, the processing proceeds to step S103. Step S1203 follows step S103.

In step S1203, the CPU 102 generates a post-color-degeneration-correction table on the basis of the following information.
The image data obtained in step S101
The image data after the gamut mapping performed in step S103
The gamut mapping table used in step S103

The processing for generating a post-color-degeneration-correction table of step S1203 is similar to the processing for generating a post-color-degeneration-correction table of step S104 in the case of no color variation reduction target color. Step S105 follows step S1203. On the other hand, in step S1001, in a case where it is determined that the image data obtained in step S101 is not the first page of a document that includes a plurality of pages, the processing proceeds to step S1201.

In step S1201, the CPU 102 performs gamut mapping for the color information of the combined color information of the page currently being processed and the color information of the previous page. Specifically, in a case where the input colors of the previous page are A, B, and C, and the input colors of the current page are B and C, gamut mapping is performed for the current page using the input colors A, B, and C.

In step S1202, the CPU 102 generates a post-color-degeneration-correction table on the basis of the following information.
Image data input in step S101 (page currently being processed)
   Color information of previous page
   Image data after the gamut mapping performed in step S1201 including color information of both the current page and the previous page
   The gamut mapping table used in step S1201

Note that the gamut mapping table used in step S1201 is the same as the gamut mapping table used in step S103. The differences between the processing to generate the post-color-degeneration-correction table of step S1202 and that of step S104 will now be described. First, in step S201, the color information of the previous page is added to the color information of the image data obtained in step S101 (that is, the page currently being processed), and a unique color is detected. In other words, processing is executed to detect whether the color of the previous page is present in the page currently being processed. As in the example described above, the input color A is not in the page currently being processed, but processing is executed as if the input color A is present. Next, the color information of the previous page is added to the color information of the page currently being processed, and the processing of step S202 is executed. The processing from hereafter is similar to the flow of processing for generating a post-color-degeneration-correction table of step S104 in the case of no color variation reduction target color.

After the processing of step S1202 or step S1203, the processing of steps S105 and S106 is executed.

After step S106, in step S1204, the CPU 102 stores the color information included in the image data obtained in step S101 in the RAM 103 or the storage medium 104. After step S1204, the processing of step S1004 is executed.

As described above, according to the present embodiment, the color variation reduction processing is executed on the basis of not only the information of the page currently being processed but also the information of the previous page. Accordingly, even with different pieces of image data, a color with the same characteristic, for example, a color with the characteristic of being common across pages, is made easier to be determined the color variation reduction target using across-page likelihood. As a result, color variation in the same color at input across different pages can be suppressed, and the color degeneration reduction result can be maintained as much as possible for other colors.

### Third Embodiment

The differences between the third embodiment and the first embodiment and the second embodiment will be described below. In the first embodiment and the second embodiment, the color variation reduction target color is determined from the color supplementary information. Here, even if the user wishes for a color to be made the color variation reduction target, due to the image data configuration, it may not be made the color variation reduction target color. In the present embodiment, the user can directly set the color variation reduction target color. Accordingly, the user can set the color variation reduction target color to the color they desire.

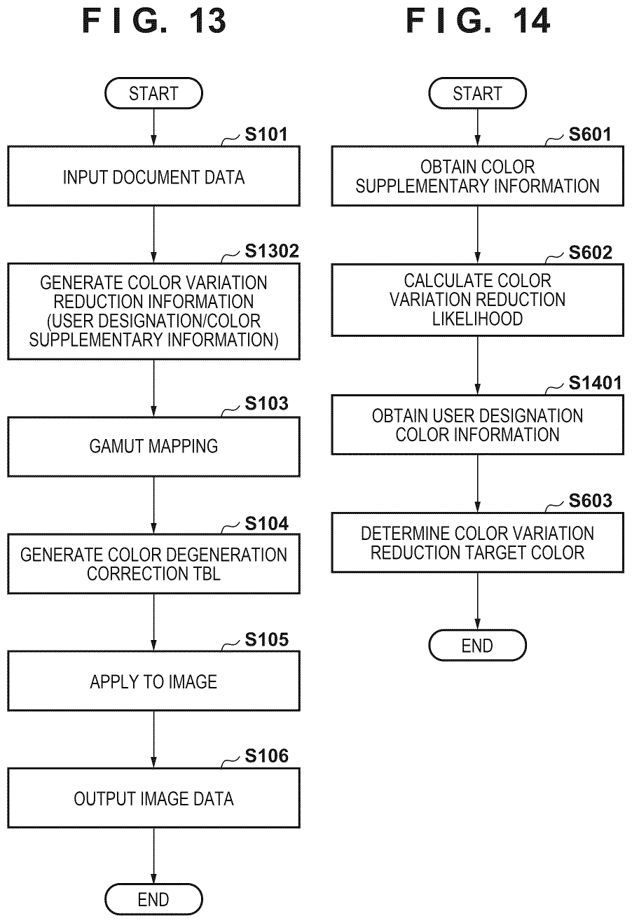

FIG. 13 is a flowchart illustrating the overall processing of the image processing apparatus 101. The processing in FIG. 13 is implemented by the CPU 102 reading out a program stored in the storage medium 104 on the RAM 103 and executing the program, for example. Also, the processing of FIG. 13 may be executed by the image processing accelerator 105. Note that for the step numbers that are the same as in FIG. 3, the steps are the same as the steps in FIG. 3, and descriptions thereof are omitted.

Step S1302 follows step S101. In step S1302, the CPU 102 obtains the color supplementary information and obtains the information of the color variation reduction target color designated by the user. Then, on the basis of the color supplementary information and the information of the color variation reduction target color designated by the user, the CPU 102 determines the color variation reduction target color and generates color variation reduction information.

FIG. 14 is a flowchart illustrating the processing of step S1302. Note that for the step numbers that are the same as in FIG. 6, the steps are the same as the steps in FIG. 6, and descriptions thereof are omitted. Step S1401 follows steps S601 and S602.

In step S1401, the CPU 102 obtains information of the color variation reduction target color designated by the user. Designation of the color variation reduction target color by the user will be described below. In step S1401, the information of the color variation reduction target color designated by the user and the color information of the page currently being processed are compared, and in a case where the color information of the page currently being processed includes information of the color variation reduction target color designated by the user, the in-page likelihood of that color is set to a value greater than the maximum value calculable.

For example, the in-page likelihood is calculated by finding the product of three values, a value calculated using the pixel number, a value calculated using the rectangular region size, and a value calculated using its location. Here, examples of methods for calculating each value are specified below.
When the pixel number is less than a threshold, the value is 0. When the pixel number is equal to or greater than the threshold, the value is +1.
When the rectangular region size is less than a threshold, the value is 0. When the rectangular region size is equal to or greater than the threshold, the value is +1.

In the case of a location with the X coordinate and the Y coordinate of the start coordinates and the X coordinate and the Y coordinate of the end coordinates of the rectangular region where the input color is present each belonging in the paper end region, +0.5 is added each time.

In the present embodiment, the in-page likelihood of the color variation reduction target color designated by the user is set to a value greater than the maximum value calculable. In a case where the maximum value calculable is calculated as (1+1)×(1+1)×(1+0.5+0.5+0.5+0.5)=12, a value greater than the maximum value of 13 is set as the in-page likelihood of the color variation reduction target color designated by the user.

Next, in step S603, the CPU 102 determines the color variation reduction target color on the basis of the calculated in-page likelihood. In step S1401, the color designated by the user is always determined as the color variation reduction target color due to the in-page likelihood set for the color information designated by the user being the maximum value. The processing thereafter is similar to that of the first embodiment.

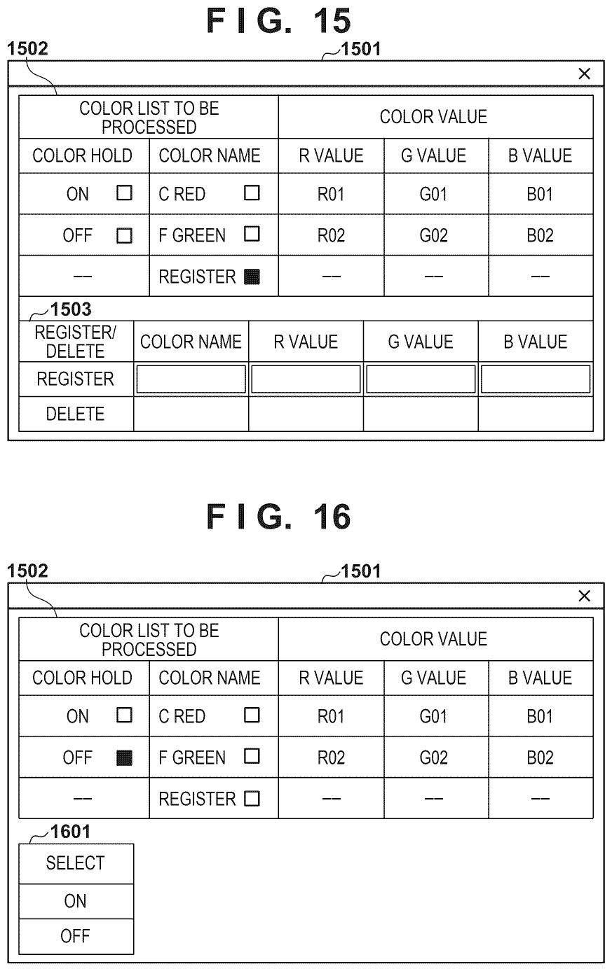

FIG. 15 is a diagram illustrating an example of a user interface screen for accepting the setting of the color variation reduction target color from the user. A setting screen 1501 for the color variation reduction target color includes a region 1502 and a region 1503. The region 1502 is a region where a color variation reduction target color list is displayed.

In the color variation reduction target color list, color variation reduction target colors registered by the user are displayed as a list. In the color variation reduction target color list, color name and color value (R value, G value, B value) are registered. In the example illustrated in FIG. 15, two colors are registered, C red (R value=R01, G value=G01, B value=B01) and F green (R value=R02, G value=G02, B value=B02). Also, the color variation reduction target color list includes a color hold (ON/OFF) setting for selecting whether or not to hold the registered color when printing. In the example illustrated in FIG. 15, the displayed setting state for C red is held (ON) and the displayed setting state for F green is not held (OFF). Note that “hold when printing” refers to making it the color variation reduction target.

The region 1503 is a region for the user to edit the color variation reduction target color list. In FIG. 15, a state is illustrated where the user has pressed the “Register” button in the region 1502 where the color variation reduction target color list is displayed to register a third color. The blacked out rectangle in the diagram indicates that this has been pressed, and a whited out rectangle indicates that this can be pressed.

In the region 1503, regions for inputting and registering the color name and color values (R value, G value, B value) are displayed. After the user has input into the region the required information and pressed the “Register” button from the “Register/Delete” selection at the left end, the third color is registered. In a case where the “Delete” button is pressed, the third color is not registered. The region 1503 is used to update or delete the registration information of the already registered “C red” and “F green”. For example, in the case of updating or deleting the registration information of “C red”, the region 1503 is displayed by the “C red” portion of the color name being pressed. In this state, if “Delete” in the region 1503 is pressed, the registration information of “C red” is deleted.

FIG. 16 is a diagram illustrating the state of the setting screen 1501 of FIG. 15 when a button for setting the color variation reduction target color is pressed. In this example, FIG. 16 illustrates a state in which the user has pressed the “OFF” display button for setting whether to set “F green” registered as the second color as the color variation reduction target color at the time of printing.

A region 1601 is displayed on the setting screen 1501. In the region 1601, ON/OFF is displayed in a selectable state. If the user selects “ON” in the region 1601, the color hold for “F green” is set to “ON”. However, if the user selects “OFF”, the color hold for “F green” remains as “OFF”.

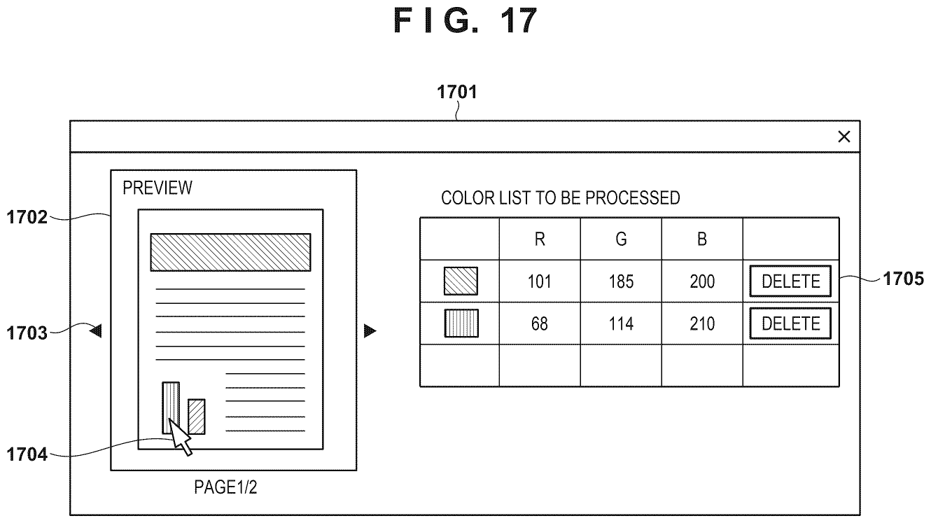

FIG. 17 is a diagram illustrating another example of a user interface screen for accepting the setting of the color variation reduction target color from the user. A setting screen 1701 for the color variation reduction target color includes a region 1702, a switch page button 1703, and a region 1705. The region 1702 is a region where an image of the document data is displayed. Also, in a case where the document data includes a plurality of pages, the switch page button 1703 is displayed. The page displayed in the region 1702 can be switched, by the user pressing the switch page button 1703. The region 1705 is a region where a list of the color variation reduction target colors is displayed.

The user moves a cursor 1704 in the region 1702 and presses on the color on the document image displayed in the region 1702 which is desired to be subjected to color variation reduction. When the user presses on the color, the color is registered in the region 1705. Also, when the user presses the “Delete” button displayed in the region 1705, the registered color is deleted.

As described above, in a case where the color variation reduction target color is set on the screens of FIGS. 15 to 17, the information of the color variation reduction target color designated by the user in step S1401 can be obtained, and the color can be determined as the color variation reduction target color.

### Fourth Embodiment

The differences between the fourth embodiment and the first to third embodiment will be described below. In the first embodiment, when performing color degeneration correction, color degeneration correction is performed per single color. Thus, depending on the combination of the colors in the input image data, the degree of color degeneration may be reduced, but the tint may be changed. Specifically, for two colors with a different hue angle, when performing color degeneration correction, the color is changed due to a change in the hue angle, making the tint different from that of the color in the input image data. For example, in the case of performing correction of color degeneration caused by a change in the hue angle for a blue color and a purple color, the purple color changes to a red color. If the tint is changed, there is a possibility of making the user think that something is wrong with the apparatus, such as that there is an ink discharge defect.

Also, in the first embodiment, when performing color degeneration correction, color degeneration correction is repeated a number of times corresponding to the number of combinations of unique colors in the input image data. Thus, the distance between colors can be reliably spread out. However, in a case where the number of unique colors in the input image data is large, as a result of colors being changed to increase the distance between colors, the distance between colors of another unique color at the changed location may be decreased. Thus, the CPU 102 needs to repeat the processing of the color degeneration correction in step S205 so that all of the combinations of unique colors in the input image data are given the expected distance between colors. Since the amount of processing for increasing the distance between colors is increased, the processing time is also increased. In the present embodiment, in the case of performing color degeneration correction, color degeneration correction is performed in the same correction direction for one color group including a plurality of unique colors per predetermined hue angle. Since correction is performed on a plurality of unique colors as one color group, a unique color can be selected from the color group as a reference. By restricting the correction direction to the lightness direction, a change in the tint can be suppressed. Since correction is performed on a plurality of unique colors as one color group, processing of all of the combinations of colors in the input image data is not necessary, allowing the processing time to be reduced. First, an example in which none of the colors to be processed are color variation reduction target colors will be described. An example in which a color variation reduction target color does exist in the colors to be processed will be described below.

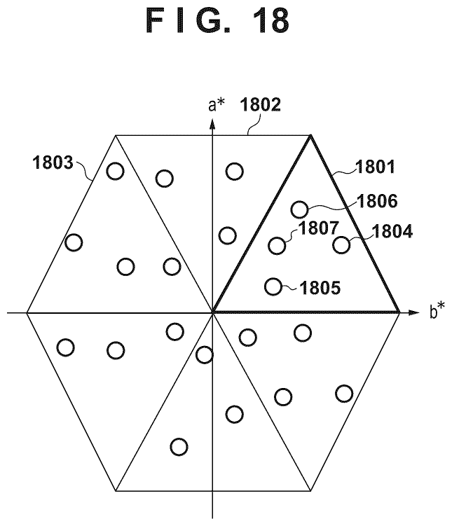

FIG. 18 is a schematic view for describing the color degeneration determination processing of step S202 according to the present embodiment. Two axes in the CIE-L*a*b* color space, the a* axis and the b* axis, are represented on a plane. A hue range 1801 represents a range in which a plurality of unique colors within a predetermined hue angle are treated as one color group. In FIG. 18, the 360 degrees of the hue angle is split evenly into six sections, with the hue angle divided at units of 60 degrees. The hue range 1801 represents a range from 0 degrees to 60 degrees. The hue range is preferably a hue range in which the same color can be perceived. For example, the hue angle in the CIE-L*a*b* color space is a unit from 30 degrees to 60 degrees. In the case of 60 degrees, the colors can be divided into six colors, red, green, blue, cyan, magenta, and yellow. In the case of 30 degrees, the colors can be divided into the colors between the colors divided at 60 degrees. As illustrated in FIG. 18, the hue range may be a fixed determination. Also, the range may be determined depending on the unique colors included in the input image data. The CPU 102 detects, from among the combination of unique colors included in the input image data in the hue range 1801, the number of combinations of colors showing color degeneration via the processing described above. In FIG. 18, a color 1804, a color 1805, a color 1806, and a color 1807 are represented as input colors. In FIG. 18, for the combinations of the four colors, the color 1804, the color 1805, the color 1806, and the color 1807, whether or not they show color degeneration is determined. This processing is repeated for all of the hue ranges. In this manner, the number of color combinations showing color degeneration can be detected per hue range.

In FIG. 18, the detected number of combinations of colors showing color degeneration is six. In the present embodiment, the hue range is set at 60 degrees of the hue angle, but no such limitation is intended. For example, the hue range may be determined at 30 degrees of the hue angle, or the hue range may be unevenly divided. Preferably, the hue range is set to a range which forms perceptually uniform hue angles. Since colors in the same color group are visually perceived as the same color, color degeneration correction can be performed on the same colors. Also, detection may be performed for the number of combinations of colors showing color degeneration in two hue ranges including each hue range and an adjacent hue range. Alternatively, detection may be performed for the number of combinations of colors showing color degeneration in the 60 degree hue range and 30 degrees offset therefrom. In this case, the result of the one previous hue range can be applied, allowing for a more reliable color degeneration correction.

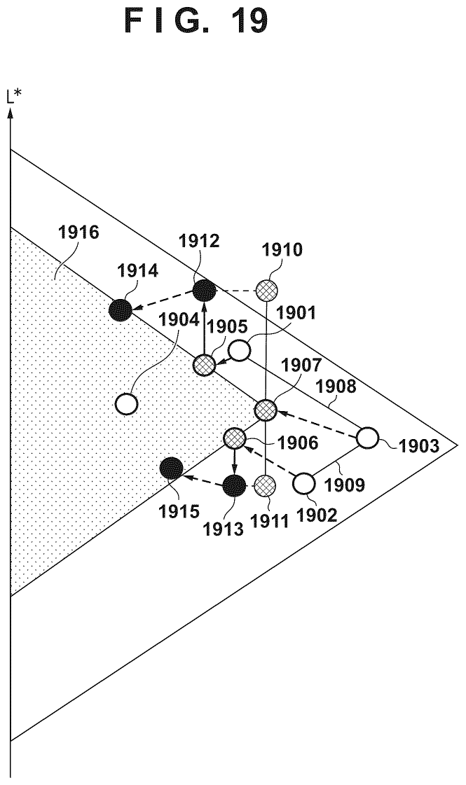

FIG. 19 is a schematic view for describing the color degeneration correction processing of step S205 according to the present embodiment. FIG. 19 is a diagram illustrating two axes in the CIE-L*a*b* color space, the L* axis and the C* axis, represented on a plane. L* represents lightness, and C* represents chroma. In FIG. 19, the input colors are a color 1901, a color 1902, a color 1903, and a color 1904. The color 1901, the color 1902, the color 1903, and the color 1904 represent the colors included in the range of the hue range 1801 in FIG. 18. Also, a color 1905 is a color obtained by color conversion of the color 1901 via gamut mapping. The color 1906 is a color obtained by color conversion of the color 1902 via gamut mapping. The color 1907 is a color obtained by color conversion of the color 1903 via gamut mapping. The color obtained after color conversion of the color 1904 via gamut mapping is represented as the same color.

First, the CPU 102 determines a unique color to serve as a reference for color degeneration correction processing for each hue range. In a preferable example, the maximum lightness color, the minimum lightness color, and the maximum chroma color are determined as reference colors. In FIG. 19, the color 1901 is the maximum lightness color, the color 1902 is the minimum lightness color, and the color 1903 is the maximum chroma color.

Next, the CPU 102 calculates a correction factor R from the number of the combinations of unique colors and the number of combinations of colors showing color degeneration in the hue range being targeted for each hue range. An example of the calculation formula is given below.

$$Correction factor R = number of combinations of colors showing color degeneration / number of combinations of unique colors \qquad ( 6 )$$

The correction factor R is lower when the number of combinations of colors showing color degeneration is low and higher when the number of combinations of colors showing color degeneration is high. As described above, with higher numbers of combinations of colors showing color degeneration, a stronger color degeneration correction can be applied. In FIG. 19, four colors in the range of the hue range 1801 of FIG. 18 are illustrated. Thus, the number of combinations of unique colors is six. Of these, four combinations show color degeneration. The correction factor in this case is 0.667. In FIG. 19, all of the combinations show color degeneration due to gamut mapping. However, in a case where the color difference is greater than the minimum color difference that can be identified even after gamut mapping, the color is not considered to be showing color degeneration. Thus, the combination of the color 1904 and the color 1903 and the combination of the color 1904 and the color 1902 are not considered to be colors showing color degeneration. Here, the minimum color difference ΔE that can be identified is 2.0, for example.

Next, the CPU 102 calculates a correction amount from the correction factor R per hue range and color information of the maximum lightness color, the minimum lightness color, and the maximum chroma color. The correction amount is calculated for a correction amount Mh on the side lighter than the maximum chroma color and a correction amount Ml on the side darker than the maximum chroma color. The color 1901, which is the maximum lightness color is represented by L1901, a1901, and b1901. The color 1902, which is the minimum lightness color is represented by L1902, a1902, and b1902. The color 1903, which is the maximum chroma color is represented by L1903, a1903, and b1903. Preferably, the correction amount Mh is a value obtained by multiplying the color difference ΔE between the maximum lightness color and the maximum chroma color by the correction factor R. Preferably, the correction amount Ml is a value obtained by multiplying the color difference ΔE between the maximum chroma color and the minimum lightness color by the correction factor R. The correction amount Mh and the correction amount Ml are calculated using Formulas (7) and (8).

$$Mh = \sqrt{{( {L}_{1901} - {L}_{1903} )}^{2} + {( {a}_{1901} - {a}_{1903} )}^{2} + {( {b}_{1901} - {b}_{1903} )}^{2}} \times R \qquad ( 7 )$$

$$Ml = \sqrt{{( {L}_{1902} - {L}_{1903} )}^{2} + {( {a}_{1902} - {a}_{1903} )}^{2} + {( {b}_{1902} - {b}_{1903} )}^{2}} \times R \qquad ( 8 )$$

As described above, the color difference ΔE to be held after gamut mapping can be calculated. The color difference ΔE to be held after gamut mapping is the pre-gamut-mapping color difference ΔE. In FIG. 19, the correction amount Mh is a value obtained by multiplying a color difference ΔE1908 by the correction factor R, and the correction amount Ml is a value obtained by multiplying a color difference ΔE1909 by the correction factor R. In a case where the pre-gamut-mapping color difference ΔE is greater than the minimum color difference that can be identified, the color difference ΔE to be held is greater than the minimum color difference ΔE that can be identified. By executing the processing in this manner, the color difference ΔE that degenerated due to gamut mapping can be restored to the color difference ΔE that can be identified. Also, the color difference ΔE to be held may be the pre-gamut-mapping color difference ΔE. In this case, the ease to identify can be brought close to that of before gamut mapping. Also, the color difference ΔE to be held may be greater than the pre-gamut-mapping color difference. In this case, the ease to identify can be improved beyond that of before gamut mapping.

Next, the CPU 102 generates a color degeneration correction table for each hue range. The color degeneration correction table is a correction table for expanding the lightness in the lightness direction on the basis of the lightness of the maximum chroma color, the correction amount Mh, and the correction amount Ml. In FIG. 19, the lightness of the maximum chroma color is a lightness L1903 of the color 1903. The correction amount Mh is the color difference ΔE1908. The correction amount Ml is the color difference ΔE1909.

The method for generating a table for expanding the lightness in the lightness direction will be described below.

The correction table for expanding the lightness in the lightness direction is a 1D LUT. The input is the pre-correction lightness, and the output is the post-correction lightness. The post-correction lightness is determined by three points, the post-correction minimum lightness, the lightness of the maximum chroma color after gamut mapping, and the post-correction maximum lightness. The post-correction maximum lightness is the lightness obtained by adding the correction amount Mh to the lightness of the maximum chroma color after gamut mapping. The post-correction minimum lightness is the lightness obtained by subtracting the correction amount Ml from the lightness of the maximum chroma color after gamut mapping. The table for expanding the lightness in the lightness direction is generated by linearly changing the post-correction minimum lightness to the lightness of the maximum chroma color after gamut mapping and linearly changing the lightness of the maximum chroma color after gamut mapping to the post-correction maximum lightness. In FIG. 19, the pre-correction maximum lightness is a lightness L1905 of the color 1901, which is the maximum lightness color. The pre-correction minimum lightness is a lightness L1906 of the color 1902, which is the minimum lightness color. The lightness of the maximum chroma color after gamut mapping is a lightness L1907 of the color 1907. The post-correction maximum lightness is a lightness L1910 obtained by adding the color difference ΔE1908, which is the correction amount Mh, to the lightness L1907. The post-correction minimum lightness is a lightness L1911 obtained by subtracting the color difference ΔE1909, which is the correction amount Ml, from the lightness L1907. FIG. 21 illustrates the correction table for expanding the lightness in the lightness direction according to FIG. 19. In the present embodiment, in a preferable example, the color degeneration correction is performed by converting the color difference ΔE to a lightness difference. Based on visual characteristics, lightness difference is highly sensitive. Thus, by also converting the chroma difference to the lightness difference, based on visual characteristics, even a small lightness difference can cause it to feel as though there is a color difference ΔE. Also, in the sRGB color gamut and the color gamut of the printing apparatus 108, the lightness difference is smaller than the chroma difference. Thus, by converting into a lightness difference, a smaller color gamut can be effectively used. Note that the lightness of the maximum chroma color is not changed to retain visual appeal. In this manner, by not changing the color with the highest chroma, the color difference ΔE can be corrected while retaining the chroma. Regarding values greater than the maximum lightness and values less than the minimum lightness, as these are not included in the input image data, setting does not need to be performed. However, in a case where the correction table is used in a complementary manner, to reference values greater than the maximum lightness and values less than the minimum lightness, values are preferably set to change linearly as illustrated in FIG. 21. As described above, the capacity can be reduced by reducing the grid number of the correction table to reduce the processing time required for correction table transfer.

Also, in a case where the post-correction maximum lightness is greater than the maximum lightness of the color gamut after gamut mapping, the CPU 102 executes maximum value clip processing. Maximum value clip processing includes subtracting the difference between the post-correction maximum lightness and the maximum lightness of the color gamut after gamut mapping in the entire correction table. In this case, the lightness of the maximum chroma color after gamut mapping is also changed to the low-lightness side. In this manner, in a case where unique colors included in the input image data are localized on the high-lightness side, by also using the lightness tone on the low-lightness side, the color difference ΔE can be expanded. Also, in a case where the post-correction minimum lightness is less than the minimum lightness of the color gamut after gamut mapping, the CPU 102 executes minimum value clip processing. Minimum value clip processing includes adding the difference between the post-correction minimum lightness and the minimum lightness of the color gamut after gamut mapping in the entire correction table. In this manner, in a case where colors included in the input image data are localized on the low-lightness side, by also using the lightness tone on the high-lightness side, color degeneration can be reduced.

Next, the CPU 102 applies the correction table generated for each hue range to the gamut mapping table. First, which correction table of which hue angle to apply is determined from the color information including a gamut mapping output value. For example, in a case where the hue angle of the output value of gamut mapping is 25 degrees, the correction table of the hue range 1801 in FIG. 18 is applied. Then, the determined correction table is applied to the output value of the gamut mapping table to perform correction. The post-correction color information is then set as a new output value after gamut mapping.

As described above, by applying a correction table generated based on a reference color also to a color other than the reference color, the correction direction is restricted to the lightness direction, allowing a change of tint to be suppressed. This removes the need for color degeneration correction processing for all of the combinations of unique colors included in the input image data, allowing the processing time to be reduced.

Furthermore, the correction table of adjacent hue ranges may be blended according to the hue angle of the output value of the gamut mapping. For example, in a case where the hue angle of the output value of the gamut mapping is Hn degrees, the color degeneration correction table of the hue range 1801 and the correction table of a hue range 1802 are blended. Specifically, the lightness value of the output value after gamut mapping is corrected by the correction table of the hue range 1801 to obtain a lightness value Lc1801. The lightness value of the output value after gamut mapping is corrected by the correction table of the hue range 1802 to obtain a lightness value Lc1802. The intermediate hue angle of the hue range 1801 is an angle H1801, and the intermediate hue angle of the hue range 1802 is an angle H1802. According to each hue angle, the post-correction lightness value Lc1801 and the post-correction lightness value Lc1802 are complemented by the hue angle of the output value after gamut mapping. The calculation formula is as follows.

$$Lc = \vert \frac{Hn - {H}_{1801}}{{H}_{1802} - {H}_{1801}} \vert \times {Lc}_{1801} + \vert \frac{Hn - {H}_{1802}}{{H}_{1802} - {H}_{1801}} \vert \times {Lc}_{1802} \qquad ( 9 )$$

As described above, by blending the correction table to be applied in accordance with the hue angle, a sudden change in the correction intensity caused by a change of the hue angle can be reduced.

In a case where the color space of the color information after correction is different from the color space of the output value after gamut mapping, the color space is converted and set as the output value after gamut mapping. For example, in a case where the color space of the color information after correction is the CIE-L*a*b* color space, conversion is performed to convert it to the output value after gamut mapping.

In a case where the post-correction value exceeds the color gamut after gamut mapping, mapping to the color gamut after gamut mapping is performed. A preferable mapping method includes color difference minimum mapping focusing on lightness and hue. In the color difference minimum mapping focusing on lightness and hue, the color difference ΔE is calculated using the calculation formulas below. In the CIE-L*a*b* color space, color information of a color that exceeds the color gamut is represented as Ls, as, and bs. Color information of a color within the color gamut after gamut mapping is represented as Lt, at, and bt. ΔL represents lightness difference, ΔC represents chroma difference, and ΔH represents hue different. Wl represents lightness weight, Wc represents chroma weight, and Wh represents hue angle weight, with a weighted color difference being represented by ΔEw.

$$Δ E = \sqrt{{( {L}_{s} - {L}_{t} )}^{2} + {( {a}_{s} - {a}_{t} )}^{z} + {( {b}_{s} - {b}_{t} )}^{2}} \qquad ( 10 )$$

$$Δ L = \sqrt{{( {L}_{s} - {L}_{t} )}^{2}} \qquad ( 11 )$$

$$Δ C = \sqrt{{( {a}_{s} - {a}_{t} )}^{z} + {( {b}_{s} - {b}_{t} )}^{2}} \qquad ( 12 )$$

$$Δ H = Δ E - ( Δ L + Δ C ) \qquad ( 13 )$$

$$Δ Ew = Wl \times Δ L + Wc \times Δ C + Wh \times Δ H \qquad ( 14 )$$

Since the color difference ΔE is expanded in the lightness direction, prioritizing lightness over chroma and performing mapping is better for correctly performing color degeneration correction. In other words, the lightness weight Wl is greater than the chroma weight Wc. Also, since the hue greatly affects the tint, prioritizes hue over lightness and chroma and performing mapping is better for keeping the change in tint before and after correction to a minimum. In other words, the hue weight Wh is equal to or greater than the lightness weight WI and greater than the chroma weight Wc. As described above, the color difference ΔE can be corrected while retaining tint. Also, the color space may be converted at the time of performing color difference minimum mapping.

Note that it is known that in the CIE-L*a*b* color space, a color change in the chroma direction does not obtain the same hue. Thus, if a change of hue angle is suppressed by increasing the hue weight, mapping to a color of the same hue is not performed. Thus, the color space may be converted into a color space in which the hue angle is bent so that a color change in the chroma direction obtains the same hue.

As described above, by performing color difference minimum mapping with weighting, a change in tint can be suppressed. In FIG. 19, the color 1905, which is the color 1901 after gamut mapping, is corrected to a color 1912 using the correction table. Since the color 1912 exceeds a color gamut 1916 after gamut mapping, mapping to the color gamut 1916 is performed. In other words, the color 1912 is mapped to a color 1914. As a result, with the post-correction gamut mapping table, if the input is the color 1901, the output is the color 1914.

Up to here, an example of executing the color degeneration correction processing of step S205 where none of the colors to be processed are color variation reduction target colors has been described using FIGS. 19 and 21.

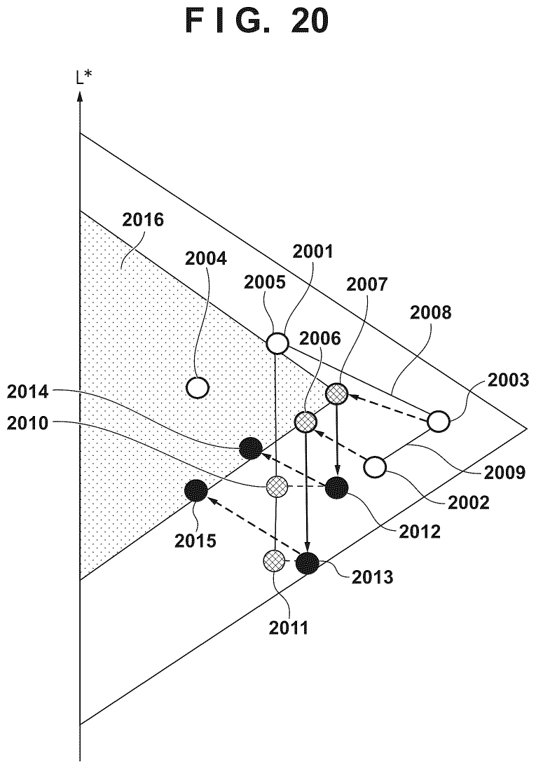

Next, an example where a color variation reduction target color does exist in the colors to be processed will be described. FIG. 20 is a diagram for describing an example of the color degeneration correction processing of step S205 where a color variation reduction target color exists in the colors to be processed. FIG. 20 is the same as FIG. 19 on the following points, and thus these will not be described.
A minimum lightness color 2002 of FIG. 20=the minimum lightness color 1902 of FIG. 19
A maximum chroma color 2003 of FIG. 20=the maximum chroma color 1903 of FIG. 19
A color 2004 of FIG. 20=the color 1904 of FIG. 19
A color gamut 2016 of FIG. 20=the color gamut 1916 of FIG. 19

Also, the maximum lightness color is a color 2001 in FIG. 20, is present in the color gamut 2016, and is the color variation reduction target color.

First, the CPU 102 calculates the correction factor R using Formula (15) from the number of the combinations of unique colors and the number of combinations of colors showing color degeneration in the hue range being targeted for each hue range.

$$Correction factor R = number of combinations of colors showing color degeneration / number of combinations of unique colors \qquad ( 15 )$$

In FIG. 20 as in FIG. 19, the correction factor R is calculated as 0.667.

Next, as in the example of FIG. 19, the CPU 102 calculates the correction amounts Mh and Ml using Formulas (16) and (17) from the correction factor R per hue range and information of the maximum lightness color, the minimum lightness color, and the maximum chroma color. The color 2001, which is the maximum lightness color is represented by L2001, a2001, and b2001. The color 2002, which is the minimum lightness color is represented by L2002, a2002, and b2002. The color 2003, which is the maximum chroma color is represented by L2003, a2003, and b2003.

$$Mh = \sqrt{{( {L}_{2001} - {L}_{2003} )}^{2} + {( {a}_{2001} - {a}_{2003} )}^{2} + {( {b}_{2001} - {b}_{2003} )}^{2}} \times R \qquad ( 16 )$$

$$Ml = \sqrt{{( {L}_{2002} - {L}_{2003} )}^{2} + {( {a}_{2002} - {a}_{2003} )}^{2} + {( {b}_{2002} - {b}_{2003} )}^{2} \times R} \qquad ( 17 )$$

Next, the CPU 102 generates a color degeneration correction table for each hue range. In FIG. 20, the lightness of the maximum chroma color is a lightness L2003 of the color 2003. The correction amount Mh is a color difference ΔE2008. The correction amount Ml is a color difference ΔE2009.

Here, in the example of FIG. 19, the lightness is expanded centered on the color 1903, which is the maximum chroma color. However, in the example of FIG. 20, since the color 2001, which is the maximum lightness color, is the color variation reduction target color, the lightness is expanded centered on the color 2001.

The pre-correction maximum lightness is a lightness L2005 of the color 2001, which is the maximum lightness color. The pre-correction minimum lightness is a lightness L2006 of the color 2002, which is the minimum lightness color. The pre-correction maximum chroma color lightness is a lightness L2007 of the color 2003.

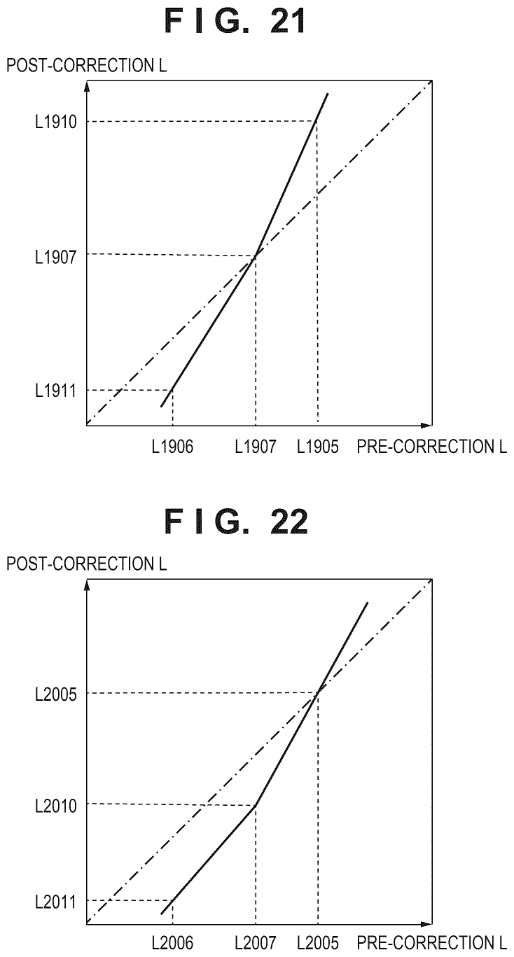

FIG. 22 illustrates the correction table for expanding the lightness in the lightness direction according to FIG. 20. The lightness of the maximum lightness color after gamut mapping remains unchanged as the lightness L2005 of the color 2001. The post-correction maximum chroma color lightness is a lightness L2010 obtained by subtracting the color difference ΔE2008, which is the correction amount Mh, from the lightness L2005. The post-correction minimum lightness is a lightness L2011 obtained by subtracting the color difference ΔE2009, which is the correction amount MI, from the lightness L2010. As described above, by expanding the lightness centered on the color variation reduction target color, the degree of color degeneration can be reduced while suppressing color correction of the color variation reduction target color. To simplify the description given above, the maximum lightness color was used as the color variation reduction target color. Below, an example where the color variation reduction target color is a lightness between the maximum lightness color and the maximum chroma color and an example where the color variation reduction target color is a lightness between the minimum lightness color and the maximum chroma color will be described.

Generating a correction table for expanding the lightness in a case where the color variation reduction target color is a lightness between the maximum lightness color and the maximum chroma color will now be described.

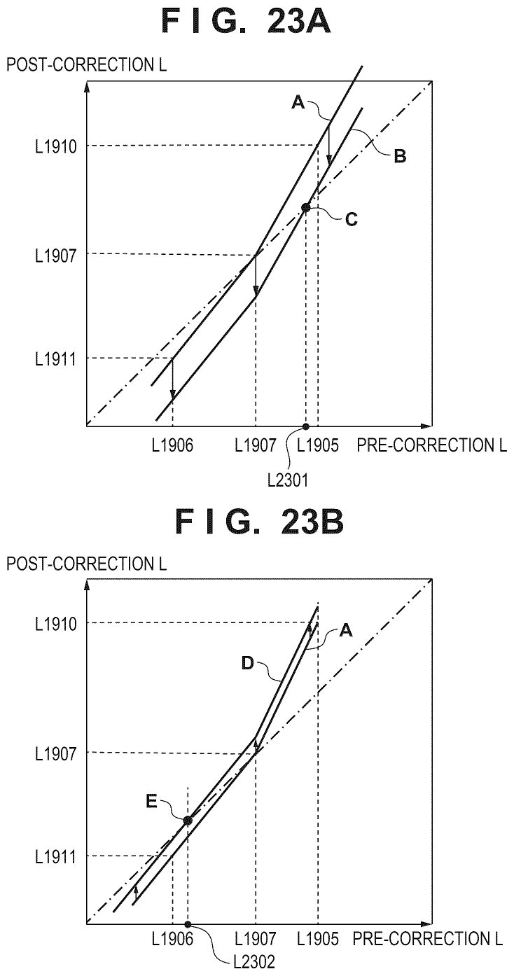

First, the correction table of FIG. 21 is generated on the basis of the color 1901 which is the maximum lightness color, the color 1902 which is the minimum lightness color, and the color 1903 which is the maximum chroma color. Then, the correction table of FIG. 21 is shifted to a position so that a lightness 2301 (illustrated in FIG. 23A) of the color variation reduction target color remains unchanged after correction.

FIG. 23A is a diagram illustrating the result (graph B) of shifting the correction table (graph A) of FIG. 21 in the downward direction to a position C so that the lightness 2301 of the color variation reduction target color remains unchanged after correction. As illustrated in FIG. 23A, the lightness 2301 of the color variation reduction target color remains unchanged after correction. Thus, the lightness can be expanded in the lightness direction while removing a change in the lightness of the color variation reduction target color.

Next, generating a correction table for expanding the lightness in a case where the color variation reduction target color is a lightness between the minimum lightness color and the maximum chroma color will be described.

First, the correction table of FIG. 21 is generated on the basis of the color 1901 which is the maximum lightness color, the color 1902 which is the minimum lightness color, and the color 1903 which is the maximum chroma color. Then, the correction table of FIG. 21 is shifted to a position so that a lightness 2302 (illustrated in FIG. 23B) of the color variation reduction target color remains unchanged after correction.

FIG. 23B is a diagram illustrating the result (graph D) of shifting the correction table (graph A) of FIG. 21 in the upward direction to a position E so that the lightness 2302 of the color variation reduction target color remains unchanged after correction. As illustrated in FIG. 23B, the lightness 2302 of the color variation reduction target color remains unchanged after correction. Thus, the lightness can be expanded in the lightness direction while removing a change in the lightness of the color variation reduction target color.

Also, in an example where the color variation reduction target color is a lightness between the maximum lightness color and the maximum chroma color and in an example where the color variation reduction target color is a lightness between the minimum lightness color and the maximum chroma color, the correction table for expanding the lightness in the lightness direction may be generated via a different method.

Another method for generating a correction table for expanding the lightness in a case where the color variation reduction target color is a lightness between the maximum lightness color and the maximum chroma color will now be described.

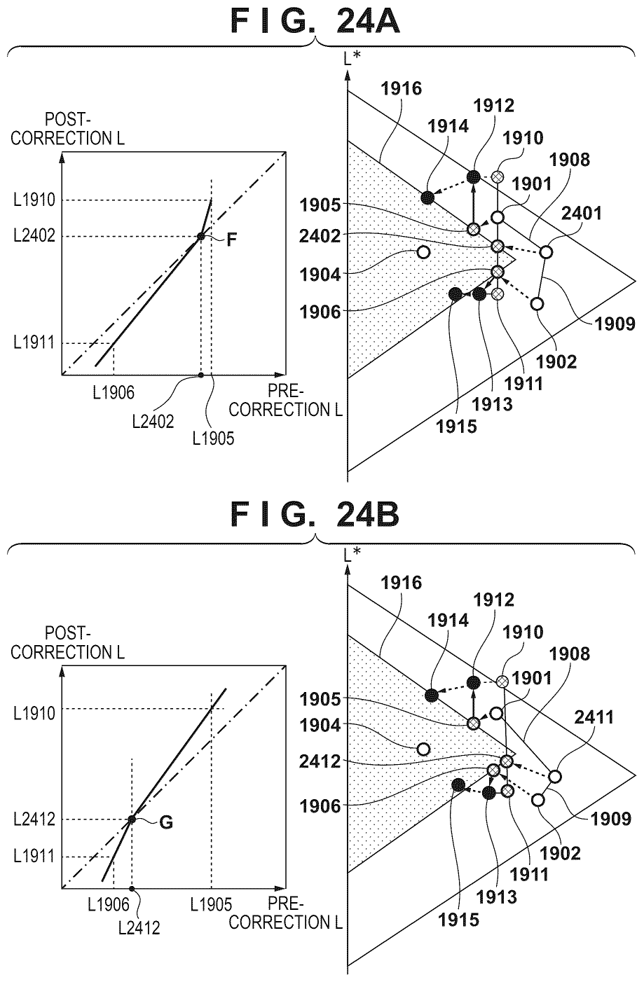

A correction table is generated using a similar method to the correction table of FIG. 21 on the basis of the color 1901 which is the maximum lightness color, the color 1902 which is the minimum lightness color, and a color variation reduction target color 2401 in FIG. 24A. In other words, the post-correction lightness is determined by three points, the post-correction minimum lightness, the lightness of the color variation reduction target color after gamut mapping, and the post-correction maximum lightness. The post-correction maximum lightness is the lightness obtained by adding the correction amount Mh to the lightness of the color variation reduction target color after gamut mapping. The post-correction minimum lightness is the lightness obtained by subtracting the correction amount Ml from the lightness of the color variation reduction target color after gamut mapping. Note that here, the correction amounts Mh and Ml are calculated using Formulas (7) and (8) but substituting L1903, a1903, and b 1903 for L2401, a2401, and b2401.

The table for expanding the lightness in the lightness direction is generated by linearly changing the post-correction minimum lightness to the lightness of the color variation reduction target color after gamut mapping and linearly changing the lightness of the color variation reduction target color after gamut mapping to the post-correction maximum lightness. FIG. 24A illustrates a correction table generated as a result of the method described above. As illustrated at point F in FIG. 24A, a lightness 2402 of the color variation reduction target color remains unchanged after correction.

Another method for generating a correction table for expanding the lightness in a case where the color variation reduction target color is a lightness between the minimum lightness color and the maximum chroma color will now be described.

A correction table is generated using a similar method to the correction table of FIG. 21 on the basis of the color 1901 which is the maximum lightness color, the color 1902 which is the minimum lightness color, and a color variation reduction target color 2411. In other words, the post-correction lightness is determined by three points, the post-correction minimum lightness, the lightness of the color variation reduction target color after gamut mapping, and the post-correction maximum lightness. The post-correction maximum lightness is the lightness obtained by adding the correction amount Mh to the lightness of the color variation reduction target color after gamut mapping. The post-correction minimum lightness is the lightness obtained by subtracting the correction amount Ml from the lightness of the color variation reduction target color after gamut mapping. Note that here, the correction amounts Mh and Ml are calculated using Formulas (7) and (8) but substituting L1903, a1903, and b1903 for L2411, a2411, and b2411.

The table for expanding the lightness in the lightness direction is generated by linearly changing the post-correction minimum lightness to the lightness of the color variation reduction target color after gamut mapping and linearly changing the lightness of the color variation reduction target color after gamut mapping to the post-correction minimum lightness. FIG. 24B illustrates a correction table generated as a result of the method described above. As illustrated at point G in FIG. 24B, a lightness 2412 of the color variation reduction target color remains unchanged after correction.

In the present embodiment, a correction table is generated for each hue range. However, a correction table may be generated for combined adjacent hue ranges. Specifically, the number of combinations of colors showing color degeneration in a hue range including both the hue range 1801 and the hue range 1802 in FIG. 18 is detected. Next, the number of combinations of colors showing color degeneration in a hue range including both the hue range 1802 and the hue range 1803 is detected. By performing detection by overlapping each hue range, it is possible to suppress a sudden change of the number of combinations of colors showing color degeneration, at the time of crossing the hue ranges. A preferable hue range in this example is a hue angle range obtained by coming two hue ranges in which the same color can be perceived. For example, the hue angle range in the CIE-L*a*b* color space in which the same color can be perceived is 30 degrees. Accordingly, by generating a correction table every 15 degrees, a sudden change in the correction intensity across hue ranges can be suppressed.

In the present embodiment, the color difference ΔE is corrected in the lightness direction by treating a plurality of unique colors as one group. Based on visual characteristics, the lightness difference sensitivity is different depending on the chroma. Sensitivity to a lightness difference of low chroma is higher than sensitivity to a lightness difference of high chroma. Thus, the correction amount in the lightness direction may be controlled depending on the chroma value. For example, for low chroma, correction is performed with a small correction amount, and for high chroma, correction is performed with the correction amount described above. Specifically, when the correction table is applied to the gamut mapping table, the pre-correction lightness value Ln and the post-correction the lightness value Lc are divided by a chroma correction factor S. The chroma correction factor S is calculated on the basis of a chroma value Sn of the output value of the gamut mapping and a maximum chroma value Sm of a color gamut after gamut mapping at the hue angle of the output value of the gamut mapping. The calculation formula corresponds to Formulas (18) and (19).

$$S = Sn / Sm \qquad ( 18 )$$

$${Lc}^{′} = S \times Lc + ( 1 - S ) \times L n \qquad ( 19 )$$

Also, in the low chroma color gamut, the correction amount may be zero. In this manner, a color change on the gray axis can be suppressed.

By performing color degeneration correction in this manner, color degeneration correction taking into account visual sensitivity can be performed. This can reduce excessive correction.

As described above, according to the present embodiment, by suppressing the color correction of the color variation reduction target color, a change in color caused by the color degeneration correction for a color for which it is important that the tint is the same across pages can be suppressed while the effect of dynamic color degeneration correction can be maintained.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-100743, filed Jun. 21, 2024, which is hereby incorporated by reference herein in its entirety.

What is claimed is:

1. An image processing apparatus comprising:
a first obtaining unit configured to obtain color information of a first color gamut specified in image data;
a color conversion unit configured to convert the color information of the first color gamut obtained by the first obtaining unit into color information of a second color gamut narrower than the first color gamut;
a correction unit configured to correct the color conversion unit so that a conversion destination in the second color gamut for conversion by the color conversion unit of the color information of the first color gamut is changed;
a second obtaining unit configured to obtain information indicating a characteristic of the color information of the first color gamut obtained by the first obtaining unit in an image represented by the image data;
a setting unit configured to, on a basis of the information indicating a characteristic of the color information of the first color gamut obtained by the second obtaining unit, set color information corresponding to a target for suppressing correction by the correction unit from among the color information of the first color gamut obtained by the first obtaining unit; and
a control unit configured to control the correction unit to suppress correction of color information set by the setting unit.

2. The image processing apparatus according to claim 1, wherein the information obtained by the second obtaining unit includes at least one of a number of pixels of a region corresponding to the color information of the first color gamut, a position on an image of a region corresponding to the color information of the first color gamut, and a size on an image of a region corresponding to the color information of the first color gamut.

3. The image processing apparatus according to claim 2, wherein color information that corresponds to the number of pixels being larger is made easier to be set as a target for suppressing correction by the correction unit.

4. The image processing apparatus according to claim 2, wherein color information with a position of a region corresponding to the color information of the first color gamut that is closer to an end portion on an image is made easier to be set as a target for suppressing correction by the correction unit.

5. The image processing apparatus according to claim 2, wherein color information that corresponds to the size being larger is made easier to be set as a target for suppressing correction by the correction unit.

6. The image processing apparatus according to claim 1, further comprising a third obtaining unit configured to obtain information indicating a characteristic of the color information of the first color gamut specified in second image data different from the image data, and
on a basis of the information indicating a characteristic of the color information of the first color gamut obtained by the second obtaining unit and the information indicating a characteristic of the color information of the first color gamut obtained by the third obtaining unit, the setting unit sets color information corresponding to a target for suppressing correction by the correction unit from among the color information of the first color gamut obtained by the first obtaining unit.

7. The image processing apparatus according to claim 6, wherein on a basis of a result of comparing the information obtained by the second obtaining unit and the information obtained by the third obtaining unit, the setting unit sets color information corresponding to a target for suppressing correction by the correction unit from among the color information of the first color gamut obtained by the first obtaining unit.

8. The image processing apparatus according to claim 7, wherein among the color information of the first color gamut obtained by the first obtaining unit, color information with more similarity between information obtained by the second obtaining unit and information obtained by the third obtaining unit is made easier to be set as a target for suppressing correction by the correction unit.

9. The image processing apparatus according to claim 6, wherein the image data and the second image data are each pieces of data corresponding to a page included in a document.

10. The image processing apparatus according to claim 9, wherein a page corresponding to the second image data is a page before a page corresponding to the image data.

11. The image processing apparatus according to claim 6, wherein the image data is image data included in a document, and the second image data is image data included in a document different from the document.

12. The image processing apparatus according to claim 6, wherein the color information of the first color gamut specified in the second image data is carried over from the second image data to the image data.

13. The image processing apparatus according to claim 12, wherein the carried over color information is stored as the color information of the first color gamut specified in the image data.

14. The image processing apparatus according to claim 6, wherein supplementary information supplementing the color information of the first color gamut specified in the second image data is carried over from the second image data to the image data.

15. The image processing apparatus according to claim 14, wherein in a case where the supplementary information satisfies a condition, color information corresponding to the supplementary information is stored as the color information of the first color gamut specified in the image data, and
in a case where the supplementary information does not satisfy the condition, color information corresponding to the supplementary information is not stored as the color information of the first color gamut specified in the image data.

16. The image processing apparatus according to claim 15, wherein the supplementary information is a pixel number, and the condition is the pixel number being greater than a threshold.

17. The image processing apparatus according to claim 16, wherein the supplementary information is carried over while decreasing.

18. The image processing apparatus according to claim 1, wherein in a case where the color information of the first color gamut obtained by the first obtaining unit includes color information designated by a user, the setting unit sets the color information designated by the user as a target for suppressing correction by the correction unit.

19. The image processing apparatus according to claim 1, wherein the correction unit corrects the color conversion unit so that a color difference in the second color gamut after conversion by the color conversion unit is increased.

20. The image processing apparatus according to claim 19, wherein the correction unit corrects the color conversion unit so that the color difference is at least made a predetermined color difference.

21. The image processing apparatus according to claim 19, wherein the control unit controls the correction unit so that a correction amount is restricted to within a predetermined range for color information set by the setting unit.

22. The image processing apparatus according to claim 21, wherein the predetermined range is a range for correction amount in which a change in color is hard to be visually perceived by a human.

23. The image processing apparatus according to claim 19, wherein the control unit controls the correction unit so that correction is not performed on color information set by the setting unit.

24. The image processing apparatus according to claim 19, wherein the correction unit corrects the color conversion unit so that the color difference is increased in at least one direction of lightness, chroma, and hue angle.

25. The image processing apparatus according to claim 19, wherein the correction unit corrects the color conversion unit so that the color difference is increased in a lightness direction.

26. The image processing apparatus according to claim 25, wherein the correction unit corrects the color conversion unit so that the color difference is increased in a lightness direction for a distance between colors included in a predetermined hue angle.

27. The image processing apparatus according to claim 1, wherein the second color gamut is a reproduction color gamut for a printing apparatus.

28. A method executed by an image processing apparatus comprising:
obtaining color information of a first color gamut specified in image data;
converting the color information of the first color gamut obtained into color information of a second color gamut narrower than the first color gamut via a color conversion unit;
correcting the color conversion unit so that a conversion destination in the second color gamut for conversion by the color conversion unit of the color information of the first color gamut is changed;
obtaining information indicating a characteristic of the color information of the first color gamut obtained in an image represented by the image data;
on a basis of the information indicating a characteristic of the color information of the first color gamut obtained, setting color information corresponding to a target for suppressing correction by the correction unit from among the color information of the first color gamut obtained; and
controlling to suppress correction of color information set.

29. A non-transitory computer-readable storage medium that stores one or more programs including instructions, which when executed by at least one memory and at least one processor of an image processing apparatus, cause the image processing apparatus to:
obtain color information of a first color gamut specified in image data;
convert the color information of the first color gamut obtained into color information of a second color gamut narrower than the first color gamut via a color conversion unit;
correct the color conversion unit so that a conversion destination in the second color gamut for conversion by the color conversion unit of the color information of the first color gamut is changed;
obtain information indicating a characteristic of the color information of the first color gamut obtained in an image represented by the image data;
on a basis of the information indicating a characteristic of the color information of the first color gamut obtained, set color information corresponding to a target for suppressing correction by the correction unit from among the color information of the first color gamut obtained; and
control to suppress correction of color information set.
